(19) United States
(12) Patent Application Publication
(10) Pub. No.: US 2009/0035599 A1
(43) Pub. Date: Feb. 5, 2009

(54) HIGH EFFICIENCY BIOCONVERSION SURFACE MATERIALS

(76) Inventors: Yong K. Kim, North Dartmouth, MA (US); Armand F. Lewis, Mattapoisett, MA (US)

Correspondence Address: LOWRIE, LANDO & ANASTASI, LLP, ONE MAIN STREET, SUITE 1100, CAMBRIDGE, MA, 02142, US

(21) Appl. No.: 12/058,274

(22) Filed: Mar. 28, 2008

Related U.S. Application Data
(60) Provisional application No. 60/920,907, filed on Mar. 30, 2007.

(51) Int. Cl. B32B 5/02; B32B 33/00

(52) U.S. Cl. 428/596; 442/320; 428/90; 428/92; 428/36.1

(57) ABSTRACT

Flocked textile materials are disclosed as a support media for bacteria that actively biochemically convert noxious chemical species. Flocked fibrous netting materials as bioconversion support media are favorable to biological growth and provide excellent liquid (e.g. wastewater) flow through its structure as well as accommodating aeration processes. The disclosed support materials can be geometrically designed and positioned in many ways including stacked sheets/plies, rolled sheets in single or multi-walled tubes, and continuous belts or webs that can be self-cleaning and configured to operate in an automated process control mode. The disclosed support media facilitate development of compact and durable biofilter structures at a low cost.

### CROSS-REFERENCE TO RELATED APPLICATION

This application claims priority under 35 U.S.C. § 119(e) to U.S. Provisional Application Ser. No. 60/920,907 entitled “HIGH EFFICIENCY BIOCONVERSION SURFACE MATERIALS,” filed on Mar. 30, 2007, which is hereby incorporated herein by reference in its entirety for all purposes.

### BACKGROUND OF INVENTION

1. Field of the Invention

At least one embodiment of the present invention relates generally to water treatment and, more particularly, to high efficiency bioconversion surface materials for use in biofiltration operations.

2. Discussion of Related Art

The treatment of wastewater is complex, generally categorized as being a combination of chemical and biological treatments. The pH level and heavy metal concentration are generally controlled by various chemical treatments. Live bacteria that often exist in wastewater are usually destroyed by chemical oxidation treatments, such as by chlorine or ozone addition to the wastewater. Some other known methods of removing various undesirable constituents from water utilize activated charcoal, foam fractionation, zeolites, activated sludge and fluidized sand bed filters.

In most wastewaters, such as those generated during closed system aquaculture operations, toxic ammonia is formed as the result of decay of organic, especially proteinaceous material. Ammonia toxicity is somewhat dependent on temperature and pH, and is of greater concern the more heavily loaded the system.

The most common process for ammonia removal is nitrification. The process of nitrification is carried out by aerobic bacteria, such as nitrosomas and nitrobacter. Nitrosomas oxidizes ammonia to nitrite and nitrobacter oxidizes nitrite to nitrate. Nitrate is much less toxic but still can be harmful at high levels, thus even in recirculating systems a 5 to 10% water change daily is the usual practice. The nitrifying bacteria are sensitive to sudden changes in water ammonia levels, temperature, chemicals such as chlorine and hydrogen peroxide oxidizing agents and some drugs.

The conversion of the ammonia to less toxic forms of nitrogen such as nitrate ions is generally done by biochemical treatments. This treatment is referred to in practice as biofiltration although more accurately should be called bioconversion. Biofiltration is a common method of treating wastewater, such as from municipal, industrial or aquaculture origin. For the most part, the process involves bioconverting the toxic ammonia in the wastewater first to nitrite [No₂⁻] ions then to nontoxic (in moderate concentrations) nitrate [NO₃⁻] ions. The nitrifying bacteria, nitrosomas and nitrobacter, are usually grown on a substrate and the water flows over, under or through this substrate.

Two standard methods used to accomplish biofiltration of polluted water are trickling filters and rotary biological contactors (RBC's). Trickling filters are submerged and water flows either upward or downward through the substrate which may be sand or another media. These filters must be backwashed periodically and are prone to clogging depending on the type of filtration media utilized. RBC's are drum shaped with an inside substrate for attachment of bacteria. The drum is placed horizontally, approximately half (depending on bacterial load) submerged in water and slowly rotated. This system exposes the water to the bacteria and also self cleans. A disadvantage of RBC's as used currently is their relatively low available surface area and large space requirement.

In biofiltration systems, biological support media is employed to promote bacterial growth for facilitating bioconversion. In RBC's, the primary support media is typically a corrugated plastic sheet, such as a polyvinylchloride (PVC) sheet. Trickling filters may use media from rock, ceramic aggregate, and shaped plastic among other materials. Water treatment by bioconversion is a rapidly growing industry that presently does not involve many textile products.

The effect of textile flocking on the anti-biofouling of surfaces in the marine environment have been studied in which samples of flocked surfaces including flocked nylon netting were exposed in the near shore marine environment. In all cases it was found that the flocked surfaces were able to repel “hard fouling” such as barnacles and the like. (See Alms (U.S. Pat. No. 5,618,588).) The observation made in these earlier studies was the fact that flocked surfaces were found to greatly enhance marine plant and algae growth. Discussed herein, flocked nylon netting and fabrics in general serve as an unexpectedly excellent media for various biofiltration media applications. In some embodiments, for example, bioconversion of ammonia by nitrosomas and nitrobacter bacteria may be mediated. In other embodiments, the reduction of hydrogen sulfide pollutants to non-toxic byproducts may be mediated.

### SUMMARY OF INVENTION

In accordance with one or more embodiments, the invention relates generally to high efficiency bioconversion surface materials for use in biofiltration operations. In accordance with one or more embodiments, the invention relates to a biological growth support media, comprising a textile biofiltration media substrate, and an array of fibers disposed on a surface of the textile biofiltration media substrate.

Other advantages, novel features and objects of the invention will become apparent from the following detailed description of the invention when considered in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by like numeral. For purposes of clarity, not every component may be labeled in every drawing. Preferred, non-limiting embodiments of the present invention will be described with reference to the accompanying drawings, in which:

FIG. 1 illustrates Unflocked and Flocked Water Flow Resistance Test Chambers (Top #1—plain [not flocked] surface, Bottom #2—flocked surface);

FIG. 2 is a schematic representation of a Water Flow Resistance Testing Device;

FIG. 3 illustrates Ammonia Bioconversion Capabilities of “Bare” and Adhesive Coated Flat Panels;

FIG. 4 illustrates Ammonia Bioconversion Capabilities of Flocked Panels;

FIG. 5 illustrates Bioconversion of Ammonia to Nitrite/Nitrate Ions by Flocked ½″ Hole Size Nylon (nylon flock) and ⅜″ Hole Size PET Netting;

FIG. 6 illustrates Bioconversion of Nitrite Ions to Nitrate Ions by Nylon Flocked ½″ Nylon and ⅜″ PET Netting Materials;

FIG. 7 illustrates Bioconversion of Ammonia by Flocked ½″ Nylon Netting Rolled and Placed in an Open Grid PVC Plastic Tube;

FIG. 8 illustrates Bioconversion of Nitrite Ions to Nitrate Ions by Flocked ½″ Nylon Netting Rolled and Placed in An Open Grid PVC Plastic Tube;

FIG. 9 illustrates Re-circulating Trickling Biofilter [RTB] Media Testing Module (BMTM) and Operational Diagram;

FIG. 10 presents photographs of commercially available Bio-Ball® and Bio-Fill® biofilter Media Material;

FIG. 10A presents a microphotograph of a flocked netting in accordance with one or more embodiments of the present invention

FIG. 10B presents a close-up microphotograph of the flocked netting of FIG. 10A in accordance with one or more embodiments of the present invention;

FIG. 10C presents a microphotograph of a flocked planar fabric surface in accordance with one or more embodiments of the present invention;

FIG. 10D presents a microphotograph of a double-sided flocked planar fabric surface in accordance with one or more embodiments of the present invention;

FIG. 11 illustrates Bio-Conversion Reaction Rate vs. Water Flow Rate for Bio-Ball® Standard Bio-Filter Media Compared to Flocked Fabric using the RTB method;

FIG. 12 illustrates Effect of Surface Area of Flocked Media on Bio-conversion Rate (Based on 1 cubic meter volume of media material) using the RTB method;

FIG. 13 illustrates Effect of Presence of Nutrient on Re-circulating Trickling Bio-Filtration Efficiency; and

FIG. 14 illustrates Dynamic Response of Flocked Media in Re-circulating Trickling Bio-Filtration Systems.

### DETAILED DESCRIPTION

This invention is not limited in its application to the details of construction and the arrangement of components as set forth in the following description or illustrated in the drawings. The invention is capable of embodiments and of being practiced or carried out in various ways beyond those exemplarily presented herein.

In accordance with one or more embodiments, the present invention relates generally to new configurations of bioconversion surface materials for use as media in the fabrication of compact-size, biofilter water and air remediation systems. High surface area to flow resistance ratios coupled with small occupied volume is desirable.

This invention pertains to the experimental observation that fiber flocked surfaces have an unexpectedly favorable ability to support bio-growth. In accordance with one or more embodiments, flocked media may facilitate various biofiltration media applications. This serves to make flocked media an effective surface for the rapid bioconversion (using nitrosomas and nitrobacter cultures as an example) of ammonia to nitrate in closed system aquaculture as well as other wastewater treatment bioconversion operations. In other embodiments, flocked media may facilitate reduction of hydrogen sulfide pollutants to non-toxic byproducts. In other embodiments, flocked media may facilitate converting syn gas from waste cellulose or plastics to ethanol without taxing food grade corn fermentation. This bioconversion is a sustainable, environmentally sound approach. As used herein, the term “flocked” refers to the process of electrostatically coating short/cut (say 0.250″ to 0.002″ in length) textile fibers onto substrate surfaces. Flocking is the textile process whereby short textile fibers such as nylon or polyester are electrically charged in a D.C. field, then align themselves in this electrostatic field and accelerated such that they perpendicularly impinge into a substrate surface coated with an uncured (fluid) adhesive. In this manner, the short fibers are oriented perpendicular to and are assembled onto the adhesive coated surface. The adhesive is subsequently cured fixing the perpendicularly oriented array of fibers in place. While flocking is the preferred process, there are other perpendicularly oriented textile surface types are also applicable in this biofilter media invention. Any textile surface quality characterized as textured, napped, patterned, veloured, velveted or otherwise modified such as by a brushing or raising process.

In accordance with at least one embodiment, a biological growth support media is disclosed comprising a biofiltration media substrate onto which exists an array of substantially perpendicularly oriented fibers disposed on a surface of the biofiltration media substrate. For example, a plastic media support sheet of an RBC may be coated with flock fibers. While plastic, such as PVC, polyacrylic or polycarbonate, is one potential primary support media, the invention is not so limited and is equally applicable to various other primary support media compositions. In some embodiments, the substrate may be a textile material comprised of nylon, polyester, acrylic, cellulose acetate, cotton, nitrile fiber, or a combination thereof. The substrate may be of any configuration, generally planar, knitted, netting, flexible woven or non-woven fabric, screen or panel.

The fibers may be made of any material compatible with the media substrate and other constituents with which it may come into contact. In some embodiments, the flock fibers are made of a textile material. For example, the flock fibers may be nylon, polyester, acrylic, cellulose acetate, any common fibrous material, or a combination thereof. In one embodiment, the fibers may be composed of nylon (nylon6, nylon 66), polyester (PET, PTT, PBT, PLA), acrylics, polyolefin (PP, PE).

In some embodiments, the array of fibers may substantially cover the surface of the media substrate. In at least one embodiment, the density of the fiber array on the textile substrate is at least about 20 fibers per square millimeter. The fibers in the array may be of any dimension. In one embodiment, for example, the fibers may be from about 2 micrometers to about 50 micrometers in diameter. In some embodiments, the fibers may comprise filaments from about 0.25 millimeter to about 10 millimeters in length. In some embodiments, the filaments may be from about 0.25 millimeter to about 8 millimeters in length. In at least one embodiment, the filaments may be from about 0.25 millimeter to about 6 millimeters in length.

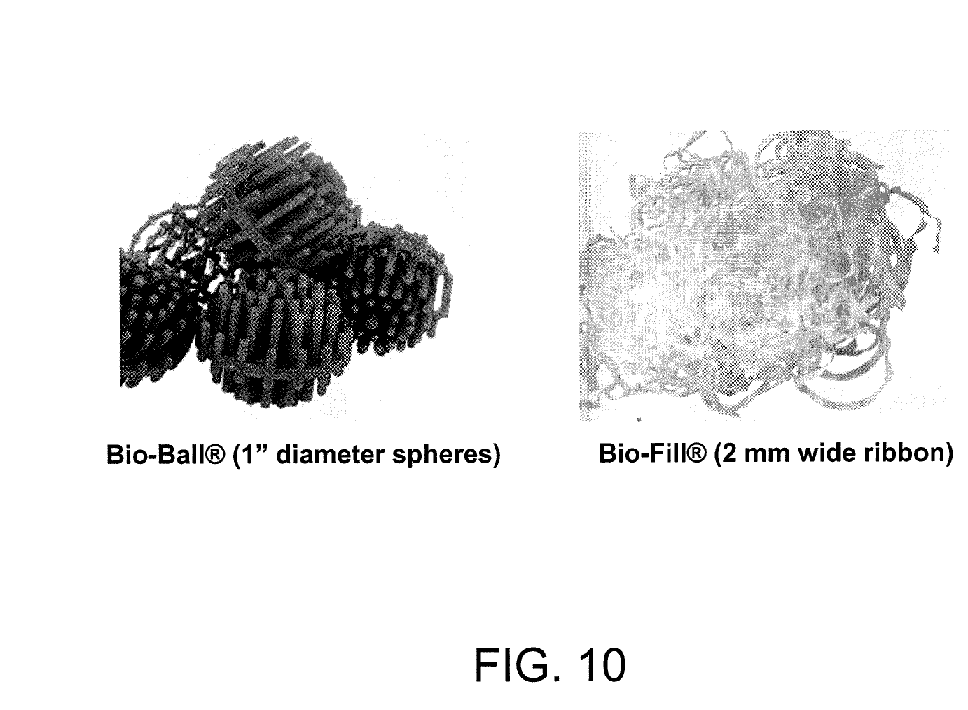

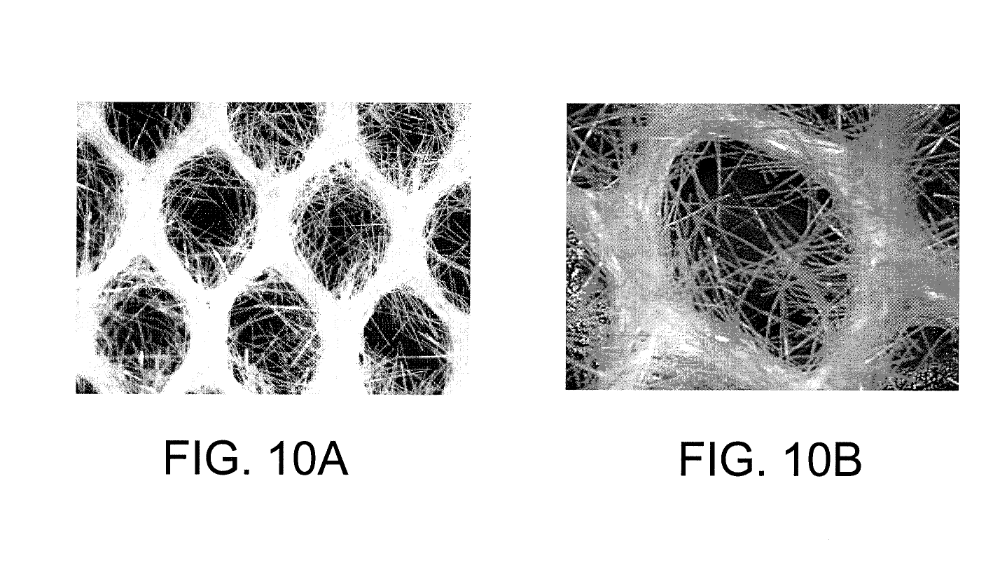

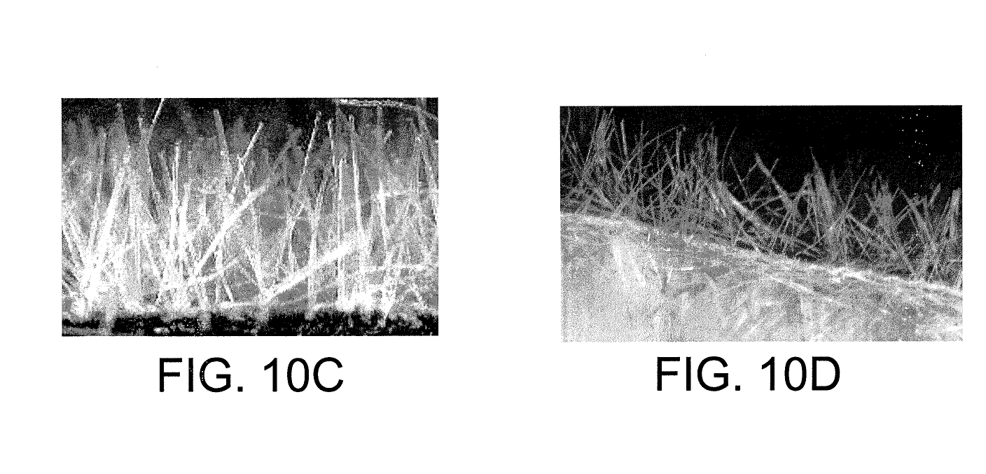

The fibers may be oriented at any desirable angle relative to a surface of the media substrate. In some embodiments, the fibers may be oriented at an angle of about 40, 50, 60 or 70 degrees relative to a plane of the flocked surface. In other embodiments, the fibers may be oriented at an angle of about 80 degrees relative to a plane of the flocked surface. In still other embodiments, the fibers may be oriented at an angle of about 85 degrees relative to a plane of the flocked surface. In at least one embodiment, the fibers may be oriented substantially perpendicular relative to a surface of the media substrate. For example, FIGS. 10A and 10B present microphotographs of flocked netting. The flocked netting contains about 8 holes per square inch and the holes are approximately 9.5 mm in nominal diameter. The flock fibers are oriented predominantly perpendicular to the netting web substrate. Likewise, FIGS. 10C and 10D present microphotographs of a flocked planar fabric surface and a double-sided flocked planar fabric surface, respectively, in accordance with one or more embodiments of the present invention. The flock fibers illustrated are 18 denier nylon 4.6 mm long fibers. The orientation of the flock fibers may be described as substantially perpendicular relative to the substrate surface.

The fibers may be attached to the biofiltration media substrate in accordance with various known techniques. For example, a binder, such as an adhesive, glue or resin, may be used to adhere the flock fibers to the primary support media. The fibers may alternatively be attached to the substrate by a flocking method.

In accordance with at least one embodiment, flocking surfaces, such as plastic sheets and textiles, have been found to greatly enhance the biological growth and bioconversion capabilities of the media substrate. This allows the bioconversion treatment of larger volumes of wastewater in the same sized RBC unit or other treatment system. Alternatively, this allows for the construction of smaller sized RBC units to perform the same level of bioconversion activity. It is expected that an order of magnitude reduction in volume/floor space is achievable when flock fiber based high specific surface area biofilter materials are used as the bioconversion media.

The present invention goes beyond the observation that flocked surfaces form excellent biosurfaces for various biofiltration media applications, for example, the reduction of hydrogen sulfide pollutants or the action of nitrosomas and nitrobacter (ammonia converting) bacteria. In accordance with one or more embodiments, flock fibers are placed on an open (knitted) net fabric structure, further enhancing the excellent bioconversion effect observed for (planar) flocked surfaces. For example, the substrate may comprise a knitted netting fabric, a perforated woven fabric, or a woven fabric screen, such as a woven fabric metal wire screen. The surface of the substrate may therefore define a plurality of apertures. The apertures may be in the range of about 0.25 millimeter to 12.7 millimeters in circular diameter or polygonal dimension. Alternatively, the apertures may be square or open rectangular in shape. In a preferred embodiment, flocked netting with a ⅛ inch to ½ inch or larger mesh size is utilized.

The openings in the net structure allows for an efficient flow of treatment water through the structure. Intimate contact of the wastewater, uniform “slime” growth on the netting surfaces and interstices is assured. Also with this open web-like structure the wastewater can more easily “slough” through the netting making it more easily accessible to the bio-reacting species. All these factors make flocked (open) netting surfaces more effective in their bioconversion function.

The flocked netting configurations disclosed have many other advantages over materials commonly used for bioconversion media. Beneficially, it can be used as a continuous web or a porous sheet. Sheets can be stacked or rolled onto each other. Significantly, the netting material can be easily cleaned by rinsing off the netting with water. This washing enables debris, alien biofouling species and/or excessive “slough” build-up on the netting to be flushed off very easily. Also, flocked fiber/yarn netting offers the opportunity of creating new forms of biofilters. For example, continuous, self-cleaning designs that can be adapted to computer control operation of wastewater treatment and aquaculture systems are possible.

In accordance with one or more embodiments, the substrate may comprise layers constructed and arranged to facilitate fluid bypass through a plane of the substrate. In some embodiments, the substrate may be rolled to define an open conduit constructed and arranged to channel fluid flow. The substrate may be constructed and arranged such that a fluid stream flows substantially parallel to the surface of the substrate, across ends of the perpendicularly oriented fibers for treatment. These and other embodiments may facilitate integrating the flocked media substrate into, for example, a biofilter.

In addition to the uses of flocked netting for RBC-like applications, many types of biosupport media used in trickling biofilter configurations could be enhanced by the application of fiber flock to the material surfaces. Adaptation of the subject invention of flocked netting materials to trickling filter configurations and new, more efficient biofilter designs are now possible.

In some embodiments, the disclosed biofilter media material can have a surface area packing density of 1000 to 5000 m²/m³ with low hydrodynamic impediment. It is conceivable that velvet, velour, raised or pile fabrics will also have a relatively high surface area packing density. However, to produce fiber based biofiltration media in massive volume at a competitive price on various forms of substrates (linear, 2-D and 3-D geometries), fiber electro-coating (flocking) appears to be the most enabling technology.

Developing a compact, cost-effective and low maintenance, continuous process bioconversion reactor substrate material/device system for application in re-circulating closed aquaculture and circulating wastewater treatment systems results in a critical economic benefit by a reduction in aquaculture process/operational floor space requirements. Primary beneficiaries may include aqua-farming operations of land based reuse-water aquaculture systems. Furthermore, the proposed bioreactor design could also be utilized in treating industrial and municipal liquid waste streams using selected micro-organisms as well as for the bio-industrial production of useful micro-organisms.

The total surface area available for bacterial growth is a good predictor of the capacity of a bioconversion media for the remediation of ammonia polluted water. The bulk surface area is an important variable that influences the cost of the biofilter vessel and support mechanisms. From an economic, including efficient floor space usage standpoint, it makes sense to use the smallest vessel possible to accomplish a given task. Provided there are no other overriding factors, using a biomedia packing with the most surface area per unit volume will allow for the minimal size vessel and unit operations costs. Vapor and liquid phase biological scrubbing technology has been growing and adapting to new applications. Emphasis is now on reducing system size while increasing throughput. Overall, the proper application of textile materials to a geometrically designed surface structure offers the potential of increasing surface contact area within a small volume. There appears to be many high quality and cost-effective benefits from the fiber-based technology herein disclosed.

It is important to distinguish between total claimed surface area and surface area that is available as a substrate for biological growth and bioconversion. As a biofilter device matures, the biomass (“slime layer”) of bacteria steadily grows and the layer of bacteria that covers all available media surfaces (biomass) becomes thicker. Since the organisms inside the layer can only receive food and oxygen by diffusion, they receive less and less food and oxygen as the biomass layer grows thicker. Generally speaking, only the outermost layer of bacteria will be operating at peak efficiency in conventional biofilter media materials. Flock fabric packing geometry is an important factor in the search for an effective bioconversion media material.

Flocked fabric media can be used to design more compact biofilter and bioconversion ammonia-water remediation systems. The surface area and fabric geometry are important factors to optimize flock fiber-coated polymer and textile fabric surfaces for bioconversion activity. Modeling and understanding the hydrodynamic flow characteristics of water across fiber coated (e.g. flocked) surfaces and, bioconversion efficiency of the fiber surface are also important.

Establishing the chemical and mechano-physical conditions that will enable the fiber coated bioconversion surfaces to be easily regenerated, should they become contaminated or coated with excessive biomass is also a consideration. In at least one embodiment, the flocked fabric biofilter media materials may be recycled by being removed from the media chamber, such as from an RBC, washed and re-conditioned with de-ionized water before being brought back online.

It is envisioned that flocked media surfaces such as those described herein may be equally applicable to bioconversion reactions in air biofilter applications.

The function and advantages of these and other embodiments of the invention can be further understood from the examples below, which illustrate the benefits and/or advantages of the system and method of the invention but do not exemplify the full scope of the invention.

### EXAMPLES

In Examples 1-4, the hydrodynamic, adhesion and biocompatibility behavior of flock materials and fiber flocked surfaces were examined as a preview to applying these flocked surfaces to functional prototype biofilters.

### Example 1

### Water Flow Against Flocked Surfaces

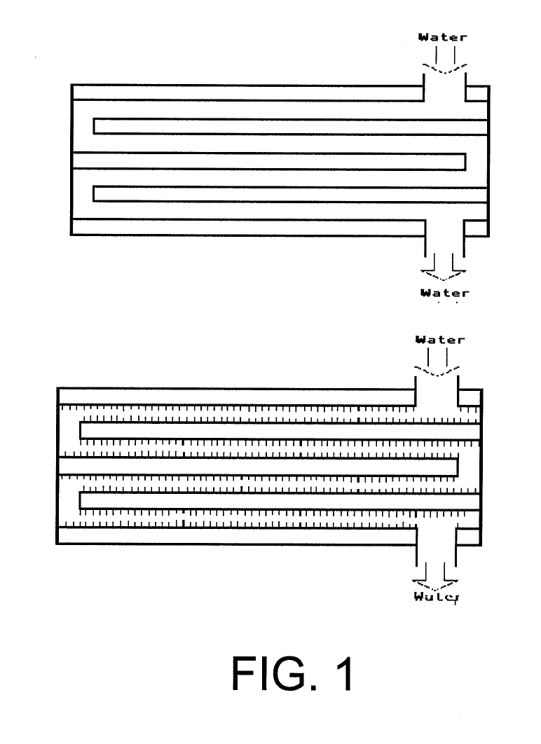

Water flow (hydrodynamics) past flocked fiber surfaces was studied. In this context, flock fiber type, denier (fiber diameter) and length were tested. To study the hydrodynamics of biofilter systems, an apparatus for measuring the flow resistance of water through slot shaped channels was constructed. In designing this apparatus consideration was given to its ultimate versatility. First, the apparatus can be used for measuring flow rates of water through several types and designs of biofilter test chambers. Furthermore, this apparatus formed the basis for possible future biochemical and biofiltration property studies. Its primary purpose however, was to study the hydrodynamic resistance of flocked surfaces. Referring to FIG. 1, the main chamber of the test device consists of 4¾″×9⅜″ stacked layers of 3/16″ thick polycarbonate (PC) sheet. The configuration of each sheet of PC alternated between: (1) sheets with a 2¾″×⅜″ slot on one end of the panel and (2) sheets with a 2¾″ wide×7″long×⅜″ deep cavity or channel which allows the water to flow across the surface of the end slotted panel.

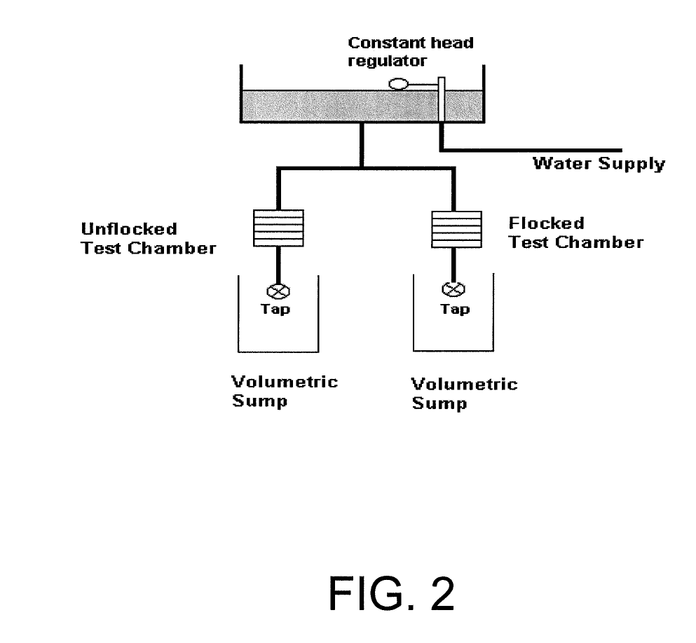

With this arrangement, the water is made to “zig-zag” through the test chamber. By stacking these panels alternately in a number of layers, a compact assembly with low overall geometric volume and a long linear water flow distance is achieved. If the surfaces of the slotted PC (#1) are flocked, the water passing through the channel in PC sheet #2 will be subjected to a flow resistance caused by the flock material (see FIG. 1). Water pressure through this apparatus was supplied by a constant level water tank held above the test chamber. Water was fed into the water channels by a connecting hose. The water is driven through the test chamber by gravity forces. In these initial studies, the flow rate of water through the test chamber was measured using a graduated cylinder (or beaker) and a stopwatch (see FIG. 2).

In some preliminary studies, an elution time of 20 seconds through the non-flocked test cell apparatus was chosen for comparative evaluations. Here, two flocked test chambers were surfaced with (1) 1.8 denier/0.05 inch long nylon flock fibers, and (2) 25 denier/0.06 inch long polyester flock fibers. The comparative non-flocked test chamber had a water flow-contact surface area of 74 m²/m³. The results of these tests are presented in Table 1. The comparable test chamber flocked with 1.8 denier nylon had a water flow-contact surface area of approximately 1364 m²/m³. With this configuration, only a 9.6% reduction in flow rate was observed when one compares flow rates in the 1.8 denier nylon flocked and unflocked polymer surface chambers under the same testing conditions. These initial tests show that the flocked chamber has significant surface area increment, but minimal drag of water flow. Note, however, that this flocked (experimental) test chamber was not optimized. Yet it was close to a 7 times higher specific water contact surface area compared to typical trickling biofilters (150-200 m²/m³ typical) and 12 times that of commercial RBC type biofilters (115 m²/m³ typical).

In additional studies, the effect of flocking mechanically stiffer fibers on the test cell flow rate was tried. When 25 denier PET (polyester) fiber was flocked onto the PC panel surface, a flock density of only 12 fibers per square micrometer was achieved. This resulted in a surface area in this cell of only 328 m²/m³. The flow rate in this 25 denier PET flocked cell was 150 ml/sec. These stiffer flock fibers were found to increase the hydrodynamic drag in the test cell with only a modest increase in surface area. This test provided some useful design information, namely, stiff flock fibers on surfaces of biofilters are capable of interfering with water flow. The next studies focused on flock fibers that are more flexible. Here it was hypothesized that surfaces with finer denier, less stiff flock fibers should be able to bend down in the direction of flow. This should cause less flow resistance.

Overall, the goal of these experiments was to determine the flock fiber surface configuration that will give the test cell the highest surface area (SA) to flow time (FT) ratio, i.e. a maximum SA/FT. These data will enable one to select a somewhat optimized flock fiber configuration for larger scale biofilter experiments. In these studies, flow time, FT, is taken as the reciprocal of the flow rate in seconds per liter. Data were obtained on a surface flocked with a lower denier PET flock fiber. Results are presented in Table 1 as well as results on the previous samples. As hypothesized, the PET 3 denier flock restricted hydrodynamic flow less than the stiffer PET 25 denier flock. The data in Table 1 are also presented in terms of the important SA/FT (Surface Area to Flow Time) ratio. Note the very high SA/FT ratio for the nylon fiber flocked sample. This result reflects the fact that nylon fibers were flocked onto the substrate at a much higher density than any of the PET flocked samples. Also, nylon fibers are inherently more flexible that PET fibers, especially in aqueous media. From a hydrodynamic viewpoint, it appears that nylon flocked surfaces is a good surface choice for prototype biofilter design/configurations.

TABLE 1
Flow Rate (FR) of Water Through Flocked Slotted Channels (all
data are an average of at least 10 replicate runs).

| | Flock Density | SA | | | |
|---|---|---|---|---|---|
| | (fibers/mm²) | (m²/m³) | FR (ml/s) | FT (s/ml) | SA/FT |
| Not Flocked | Not applicable | 74 | 304 | 3.3 | 22 |
| Nylon 1.8D, | 393 | 1364 | 253 | 4.0 | 345 |
| 0.05″ long | | | | | |
| PET 3.0D, | 27 | 218 | 243 | 4.1 | 53 |
| 0.05″ long | | | | | |
| PET 25D, | 12 | 289 | 132 | 7.6 | 38 |
| 0.06″ long | | | | | |

In some supporting work, techniques on improving the flock density of polyester (PET) fiber flocked surfaces were sought. This work was performed in order to establish the efficacy of using PET flock fibers in future biofilter designs. A formulation (Floctan) for a tannic acid D.C. flock finish was applied to the surface of 3 denier PET flock fiber. This so-treated flock fiber was first conditioned at 45 and 60% RH. These samples were then tested for (1) electrical resistivity and (2) flock activity. The flock density of this treated PET flock fiber was determined by first flocking the fiber onto a polycarbonate (PC) plastic substrate using the LUBRIZOL® FL 1059B adhesive and then measuring the flock density by a photographic/optical counting method. The results of these experiments are presented in Table 2. As shown, the FlocTan treated PET fibers conditioned at 45 or 60% RH are much more flockable than the untreated PET flock fibers. As indicated, the important flock density value doubles by applying the FlockTan DC finish to the fiber before flocking.

TABLE 2
Behavior and Flock Properties of Tannic Acid [FlockTan] (DC)
Finished PET Flock Fiber.

| | | FloctTan - | FlocTan - |
|---|---|---|---|
| | No Treatment | 45% RH | 60% RH |
| Electrical Resistivity | >10⁹ | 5 × 10⁷ | 1 × 10⁷ |
| (ohms) (a) | | | |
| Flock Activity (b) | no movement | 6.6 seconds | 6.2 seconds |
| Flock Density | 43 | 82 | 89 |
| (fibers/mm²) | | | |

(a) Measured using a Mahlo Texo Conductivity Meter.
(b) Maag Flockmaschinen SPG 1000 flock activity meter used. {The flock activity test involves placing 2 grams of flock fiber on a metal (lower) electrode “pan” (3.75″ dia.) of the flock activity tester. Above is an upper metal electrode (2.5″ dia.). These electrodes are mounted in a chamber and positioned 4″ apart. A DC electric field of 40 KV is then applied and the electrostatic activity of mass of flock fiber is visually observed. The amount of flock fiber electrostatically removed from the lower pan is measured. The measurement involves recording either: (1) the time (in seconds) for all of the (2 grams) of flock fibers to be removed from the lower pan electrode, or (2) the amount of flock fiber left on this lower pan after 2 minutes in the electric field (whichever comes first).}

### Example 2

### Adhesion Strength of Flock Fibers to Surfaces

Various flock adhesives were examined for adhesion strength, durability in water and exposure to biological media. In other supporting work, the flock-to-PC (polycarbonate) substrate adhesion strength was evaluated for the flocked test configurations presented above. The adhesion strengths were measured as prepared and also after a six-day water immersion (at RT). These results are shown in Table 3. The adhesion strength tests were performed using a Maag-Flockmachinen—MECMESIN AFG 250N tensile flock adhesion tester. The test involves placing a machined, circular, aluminum fitting having a 1 cm diameter hole at its base onto the surface of a flocked solid PC plastic (or fabric) substrate. A hot-melt adhesive is then injected into the top of this aluminum fitting so the hot-melt adhesive is absorbed by and wetted into the flock fibers. When the hot-melt adhesive solidifies (by cooling to room temperature), the aluminum fitting is now attached to a 0.785 cm area of the flocked fiber surface. This assembly is then configured into a tensile force measuring apparatus so that the force necessary to pull/tear the flock fibers away for the substrate is measured and recorded. The failure surfaces are then visually examined (optical microscope) to establish the type of failure i.e. (a) tearing of the fibers out of the adhesive, (b) failure of the flock adhesive at the substrate surface, or (c) breakage within the flock fibers themselves.

TABLE 3
Adhesion Strength of Nylon Flock Bonded to Polycarbonate
Surfaces (all pull-out strength numbers in Newtons of force).

| | | | Pull-out | |
|---|---|---|---|---|
| Adhesive | Pull-out Strength | Type of Failure | Strength* | Type of Failure* |
| Epoxy Coat - | 120 +/− 22 | Adhesion to PC | 114 +/− 57 | Adhesion to PC |
| Solvent Based | | excellent, mixed | | excellent, smooth |
| | | failure at the | | failure at |
| | | fiber/adhesive | | flock/coating |
| | | interface | | interface |
| BFG Acrylic | 107 +/− 5 | Mixed - some | 118 +/− 50 | Mixed failure - |
| Emulsion | | adhesive pulled | | Patchy, some |
| | | off the PC | | coating pulled |
| | | substrate | | away from PC |
| | | | | surface |
| LUBRIZOL ® | 136 +/− 7 | Some nylon | 135 +/− 12 | Smooth fracture |
| Water Based | | fibers remain on | | surface at |
| Acrylic | | the coated PC | | flock/coating |
| | | surface | | interface |

*immersed in water for 6 days, dried at room temperature and tensile adhesion tested.

Interpreting the nature of the failure was enhanced by treating the fracture surfaces in a fiber identification dye (DuPont #4) solution. Furthermore, the results show that water immersion does not affect adhesion strength. Also, the most consistent and highest adhesion strengths were observed with the LUBRIZOL® FL 1059B adhesive. The data indicate that the LUBRIZOL® FL 1059B adhesive performs best in the described adhesion test. If the LUBRIZOL® FL 1059B adhesive performs well in biological compatibility test (discussed in subsequent examples), it will be a good choice for use in the preparation of nylon flocked bio-surfaces. LUBRIZOL® FL 1059B adhesive is an acrylic polymer-water based flock adhesive and was used throughout this study. The use of other adhesive types such as epoxy resin and polyurethane are not excluded from use in the creation of the patented flocked structure. Flock adhesives are chosen as being able to adhere to the flock fiber as well as the substrate onto which the fibers are flocked. The added qualification in this present application is that the adhesive must also be resistant to continuous water immersion. The LUBRIZOL® FL 1059B adhesive that was used was found to satisfy all of these requirements.

For self-cleaning and continuous biofilter system designs, some (nylon) flocked yarn is under consideration as a substrate for the bio-functioning of nitrosomas and nitrobacter bacteria. Flocked yarn can be configured into strands, as an open web or else a woven or knitted fabric. Flocked yarn offers some innovative biofilter design possibilities. To this end, a supply of (nylon) flocked yarn was obtained from Filova International SA, Guillaume, Luxembourg. A flock adhesion strength test was devised to test the adherence of the (nylon) flock fiber to the (nylon) yarn “core”. The test involved clamping the tip of the flocked yarn in the grips of a conventional (electrical) wire stripper. The hole in the wire stripper is chosen so that the flock is stripped from the yarn core when the tip of the yarn is pulled through (as in stripping the insulating cover from an electrical wire). Tests were carried out where different (“tail”) lengths of the flocked yarn were stripped away from the core yarn. Tests were carried out on (1) “as received” flocked yarns, (2) “cured” yarns and (3) flocked yarns soaked in water for 7 days. The cured yarns were dried or “post cured” at 83° C. for 30 minutes.

The data obtained followed a liner relationship between the force to strip (lbs.) and the length of yarn being stripped (“tail length”), up to 1.5 cm. Also, these data could be extrapolated to a hypothetical zero length to give a value of the “intrinsic adhesion strength” of the flock fiber to the yarn core. It was found that the “post cured” samples have a slightly lower flock adhesion strength than the “as received” samples. Furthermore, water immersion does not have any drastic affect on lowering the adhesion or the flock to the core yarn. Overall, from the extrapolated-to-zero stripping length value, “intrinsic adhesion strength” of the flock fiber to the yarn ranges from 1.98 to 1.86 pounds of stripping force. Apparently, these water and heat treatments did not alter the flock yarn too drastically. From these studies, it was concluded that the (nylon) flocked yarn as received from Filova International, SA will be structurally suitable for use in prototype biofilter design configurations. The important property of biocompatibility of this flocked yarn material was determined in subsequent biocompatibility studies as discussed below.

### Example 3

### Tests for Biocompatibility of Flocked Surfaces

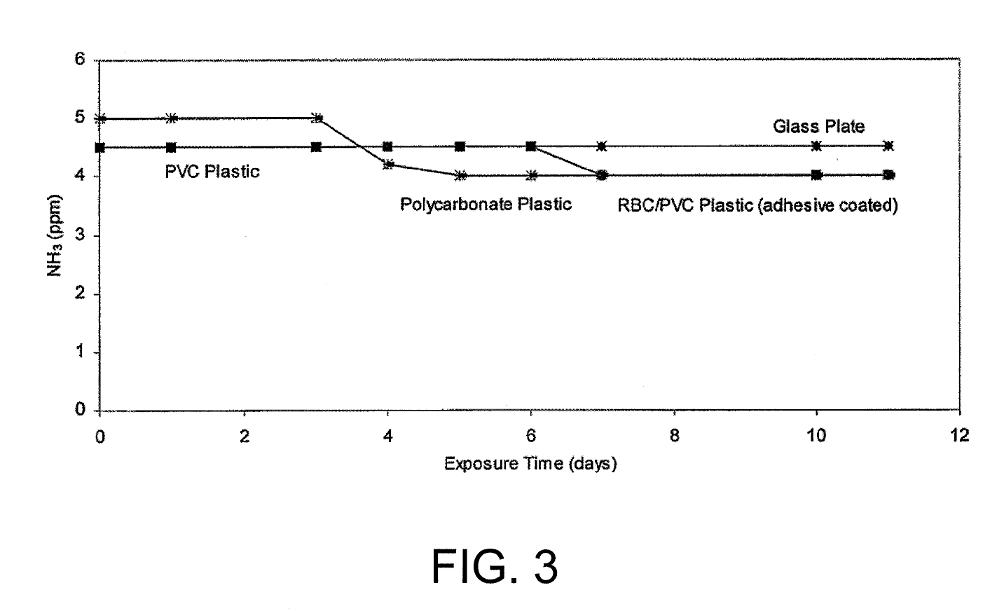

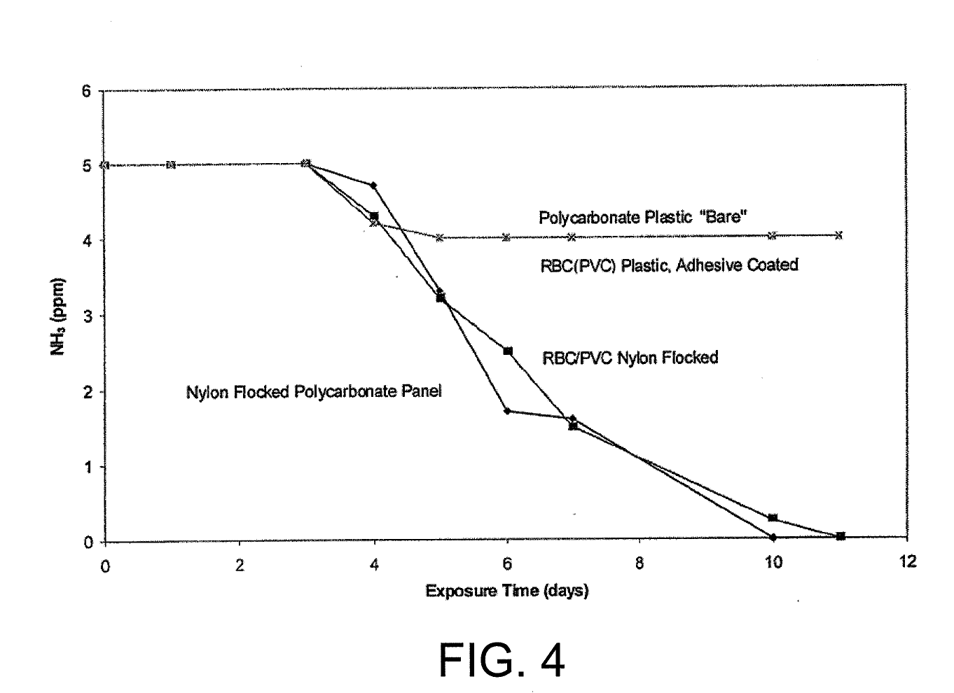

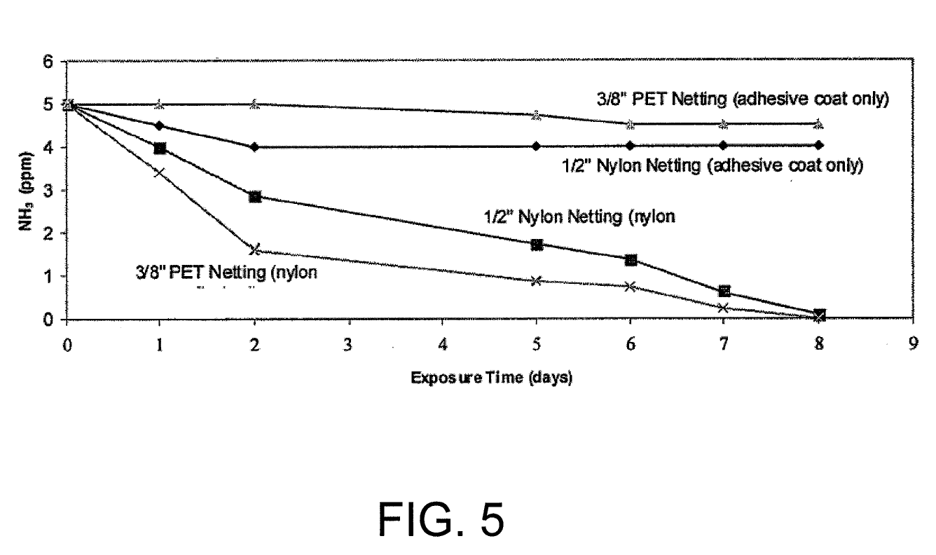

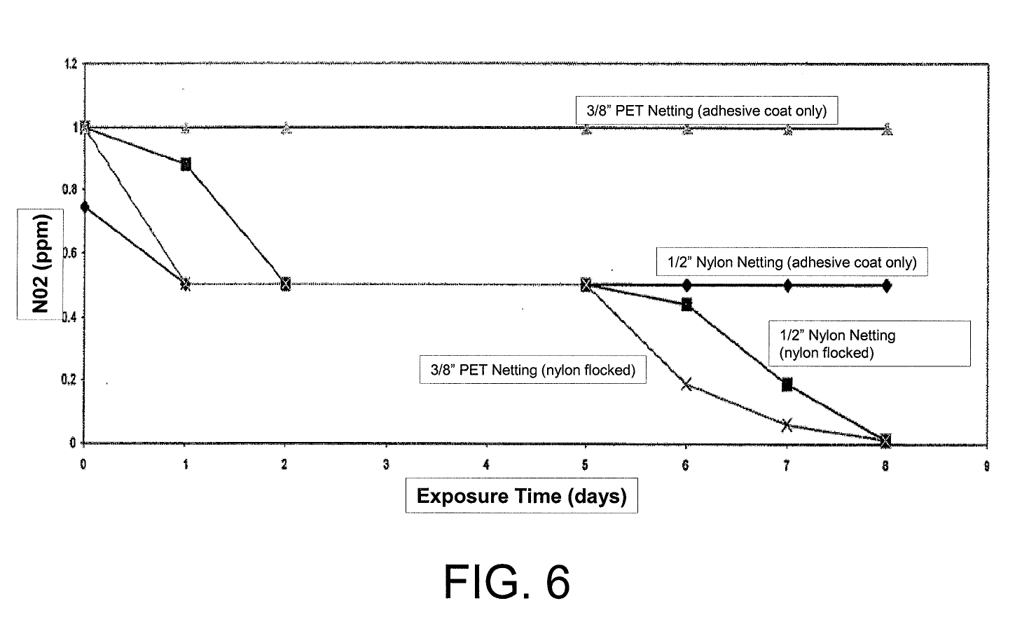

Data in Tables 4 and 5 and FIGS. 3 and 4 compare the results of several experiments that were conducted to evaluate the effectiveness of several media surfaces that are commonly used in RBC and trickling biofilter type devices. The invented nylon flocked materials are found to be much more effective bioconverting surfaces for toxic ammonia than presently used biofilter media such as glass, PVC plastic, and polycarbonate (PC) flat surfaces. Additionally, from Table 6 and 7 and FIGS. 5 and 6, it shows that flocked nylon netting is more effective in bioconversion than the flocked flat panel materials described in Tables 4 and 5 and FIGS. 3 and 4. The flocked netting material has the ability to bioconvert the ammonia at a faster rate than the flocked flat surfaces. For flocked netting, the bioconversion reaction starts during the first days of exposure time. With the flocked flat plates, however, there seems to be an “induction period” of up to about 3 days before the bioconversion reaction starts. Therefore flocked netting materials can be considered to be the preferred embodiment in this subject invention.

The biocompatibility of flocked and material surfaces was tested with the goal of choosing a suitable combination of flock type, flock adhesive and base material for the construction of prototype, operational biofilter designs and configurations. Laboratory scale nitrosomas and nitrobacter culture survival tests were conducted to determine how well the ammonia converting bacteria grow on flocked and support media surfaces. These tests enabled a determination of the efficacy of flocked fibers in biofilter applications. These in-lab biological adaptability tests were performed in UMD's Biology Department. The data obtained in these experiments will aid in determining what types of fiber flock and adhesive material will be best to use in future biofilter structures. Two types of flock and two types of adhesive were evaluated in these biocompatibility tests. All test support media were 10 cm by 20 cm samples of (1) 0.375″ thick polycarbonate [PC], (2) 0.375″ thick Polyvinylchloride [PVC] or (3) 10 cm by 20 cm rectangles of fiber based netting materials. A 45 gallon water conditioning tank and a 35 gallon back-up tank were set up for the study. Aquarium supply and culture tank chemical test kit materials were used to monitor the ammonia and nitrite content of the test chambers. In these tests, large-mouth, one gallon (volume) glass jars for the nitrosomas and nitrobacter culture survival tests were used. A recipe was determined for the preparation of the nitrosomas and nitrobacter culture media by UMD Biology Department personnel. Provisions were made for the conditioning tanks to be regulated at a pH of 7.2. Also the total ammonia nitrogen (TAN) in these conditioning tanks was maintained between 4 and 6 mg/L.

First, the flat test plates and netting materials were “extracted” in a constant water wash for about 1 week before attempts are made to grow biological cultures on them. This was done to leach out possible chemical and toxic substances from the plastic plate, fibrous netting, glass, adhesive and flock materials that were used to prepare the bioconversion test samples. This type of water conditioning is always performed when preparing various biofilter devices in commercial aquaculture operations.

### Details of Biocompatability Tests

Biocompatibility testing of flocked surfaces for biofilter effectiveness involved preparing eighteen, 10 cm×20 cm test panels of flocked, adhesive coated and bare PC plastic test panels. The samples included three replicates of each of the following: (1) “bare” Polycarbonate, PC, (2) Epoxy adhesive coated PC, (3) nylon flocked/epoxy adhesive, (4) LUBRIZOL® FL 1059B water based adhesive coated, (5) nylon flocked/LUBRIZOL® FL 1059B adhesive, (6) nylon flocked/BFG acrylic emulsion adhesive. These samples were first leached in water for one week before starting a three week bacteria exposure test. Eighteen (18) wide mouth one gallon glass jars were set up for these studies. Test panels, inoculated with nitrosomas and nitrobacter bacteria, were first immersed in a dilute (buffered) ammonia solution in water. Provisions were made for the conditioning jars to be regulated at a pH of 7.2. Also the total ammonia nitrogen (TAN) in these tanks was maintained between 4 and 6 mg/L. The concentration of ammonia was monitored as a function of time for three weeks. For the present experiments, only nylon flock fiber was tested for biocompatibility. Nylon flocked surfaces were shown to have a much lower hydrodynamic flow resistance, at the much higher surface area than PET (polyester) flocked PC surfaces.

### Results of Biocompatibility Tests

The compatibility testing of flocked surfaces for biofilter effectiveness indicated that surfaces flocked with nylon fiber are excellent substrates for the ammonia converting nitrosomas and nitrobacter bacteria. During the test, all the flocked samples showed a decrease in ammonia concentration accompanied by a decrease in nitrite ion concentration. This confirms the proper bio-functioning of the nitrosomas and nitrobacter bacteria. All the flocked panels showed (visibly) a thick growth of bacteria on their surfaces compared to the bare polycarbonate (PC) and the adhesive coated PC panels. Overall, the flocked samples using the two water based adhesives (BFG—acrylic emulsion and LUBRIZOL® FL 1059B adhesive) were found to be the most effective in converting ammonia into nitrate. The data were scattered however.

An analysis of these data and the adhesion test results reported in the previous section indicates that the nylon fiber flock (1.8 denier, 0.05″ long)/LUBRIZOL® FL 1059B adhesive flock system was the overall best system to use in future studies. Specific bioconversion data are presented in Table 4 and FIG. 3 for the comparison of “Bare” glass plate, PC, corrugated RBC/PVC (PVC as used in RBC's) and PVC plate.

From these data it is concluded that solid, flat material (not flocked) panels show little or no bioconversion effectiveness. Table 5 and FIG. 4 present bioconversion data for some of the same flat panel materials (PC, PVC and RBC/PVC) presented in Table 4 and FIG. 3. They are compared to the nylon fiber flocked panels. As shown, the nylon flocked flat panel surfaces are very effective ammonia bioconversion media for nitrosomas and nitrobacter bacteria. It was concluded that the nylon flocked PC and PVC surfaces flock-bonded using the LUBRIZOL® FL 1059B water based acrylic adhesive material is an excellent materials configuration for effectively and durably bio-converting (A) ammonia to nitrite and (B) nitrite to nitrite in various pollution control and aquaculture bioconversion devices. Note that the bioconversion effectiveness of these panels seems to be independent of the substrate material. This behavior is to be expected since the substrate is first coated with adhesive and then flocked. The base substrate material is not directly exposed to the bioactive media. The substrate is essentially encapsulated by the adhesive coating.

TABLE 4
Biochemical Conversion Effectiveness of Flat Panel Support
Materials (NH₃ and NO₂ Data in ppm).

| | Glass | | | | | | RBC/PVC | |
|---|---|---|---|---|---|---|---|---|
| Exposure | Plate | | PC | | PVC | | Adhesive | |
| Time | “Bare” | | “Bare” | | “Bare” | | Coated | |
| (days) | NH₃ | NO₂ | NH₃ | NO₂ | NH₃ | NO₂ | NH₃ | NO₂ |
| 0 | 4.5 | — | 5 | 1 | 4.5 | 1 | 5 | 1 |
| 1 | 4.5 | — | 5 | 1 | 4.5 | 1 | 5 | 1 |
| 3 | 4.5 | — | 5 | 1 | 4.5 | 1 | 5 | 1 |
| 4 | 4.5 | — | 4.2 | 1 | 4.5 | 1 | 4.2 | 1 |
| 5 | 4.5 | — | 4 | 1 | 4.5 | 1 | 4 | 1 |
| 6 | 4.5 | — | 4 | 1 | 4.5 | 1 | 4 | 1 |
| 7 | 4.5 | — | 4 | 1 | 4 | 1 | 4 | 1 |
| 10 | 4.5 | — | 4 | 1 | 4 | 1 | 4 | 1 |
| 11 | 4.5 | — | 4 | 1 | 4 | 1 | 4 | 1 |

TABLE 5
Ammonia Bioconversion Capabilities of Flocked Panels
(flat panels flocked with 1.5 denier, 0.05″ long nylon flock using
LUBRIZOL ® FL 1059B adhesive).

| | | | “Bare” PC and |
|---|---|---|---|
| Exposure Time | | RBC/PVC nylon | Adhesive Coated |
| (days) | PC nylon flocked | flocked | RBC/PVC* |
| 0 | 5 | 5 | |
| 1 | 5 | 5 | 5 |
| 3 | 5 | 5 | 5 |
| 4 | 4.7 | 4.3 | 5 |
| 5 | 3.3 | 3.2 | 4.2 |
| 6 | 1.7 | 2.5 | 4 |
| 7 | 1.6 | 1.5 | 4 |
| 10 | 0 | 0.25 | 4 |
| 11 | 0 | 0 | 4 |

*These data are added for comparison. The “bare” PC and the adhesive coated RBC/PVC showed the same low bioconversion effectiveness (see Table 4).

### Example 4

### Additional Biocompatibility Tests

To expand overall knowledge of bioconverting/biofilter materials, additional biocompatibility studies were conducted. This second study focused on the use of open-weave netting materials as the base onto which flock fibers were applied. It was considered that open net fibrous structures would allow a more uniform and easy circulation of the ammonia containing fluid water waste stream through the bioconverting media. The flocked netting configuration may also present the opportunity for creating some “self-cleaning” biofilter designs.

The biocompatibility test was carried out the same as what was described for the flat PC and PVC (see previous results). All samples were similarly conditioned and then placed into gallon jars containing the ammoniacal water solution. The study involved ½″ nylon and ⅜″ PET based knotless netting material. The LUBRIZOL® FL 1059B water based acrylic adhesive was used as the flocking adhesive. As before, the concentration of ammonia and nitrite ion was followed during the planned exposure time. The results of these bioconversion tests are presented in Table 6. As shown, the bioconversion of ammonia and nitrite ion (to nitrite/nitrate ions) shows a dramatic increase (a decrease in ammonia concentration) in the presence of the flocked netting surfaces compared to the “bare” adhesive coated netting (no flock). In additional experiments, the bioconversion capabilities of other netting configurations were determined. These test samples consisted of flocked ½″ nylon netting loosely rolled into a 6 cm diameter, 20 cm long PVC (plastic) net tube. This represents a unique biofilter configuration that is designed as a “cartridge” that can be adapted into a wastewater bioconversion device that can be easily cleaned. The ammonia/nitrite bioconversion test results of these configurations are presented in Table 7.

TABLE 6
Bioconversion Effectiveness of Flocked Netting Support Materials
(ammonia and nitrite ion concentrations in ppm).

| | ½″ Nylon | | ½″ Nylon | | ⅜″ PET | | ⅜″ PET | |
|---|---|---|---|---|---|---|---|---|
| | Net | | Net | | Net | | Net | |
| Exposure | (adhesive | | Nylon | | (adhesive | | Nylon | |
| Time | coat) | | Flocked | | coat) | | Flocked | |
| (days) | NH₃ | NO₂⁻ | NH₃ | NO₂⁻ | NH₃ | NO₂⁻ | NH₃ | NO₂⁻ |
| 0 | 5.00 | 0.75 | 5.00 | 1.00 | 5.00 | 1.00 | 5.00 | 1.00 |
| 1 | 4.50 | 0.50 | 4.00 | 0.88 | 5.00 | 1.00 | 3.44 | 0.50 |
| 2 | 4.00 | 0.50 | 2.88 | 0.50 | 5.00 | 1.00 | 1.62 | 0.50 |
| 5 | 4.00 | 0.50 | 1.75 | 0.50 | 4.75 | 1.00 | 0.88 | 0.50 |
| 6 | 4.00 | 0.50 | 1.38 | 0.44 | 4.50 | 1.00 | 0.75 | 0.19 |
| 7 | 4.00 | 0.50 | 0.62 | 0.19 | 4.50 | 1.00 | 0.25 | 0.06 |
| 8 | 4.00 | 0.50 | 0.12 | 0.01 | 4.50 | 1.00 | 0.01 | 0.01 |

TABLE 7
Bioconversion of Rolled in PVC Plastic Tube Sections Containing
½″ Netting Materials and Flocked with Nylon Fibers
(ammonia and nitrite ion concentrations in ppm).

| | | | | | Double | | | |
|---|---|---|---|---|---|---|---|---|
| | Rolled | | Rolled | | Rolls | | Flat Flocked | |
| Exposure | Netting | | Netting | | Flocked | | Netting | |
| Time | (no flock) | | (flocked) | | Netting | | (Table 2) | |
| (days) | NH₃ | NO₂⁻ | NH₃ | NO₂⁻ | NH₃ | NO₂⁻ | NH₃ | NO₂⁻ |
| 0 | 5.00 | 1.00 | 5.00 | 1.00 | 4.50 | 1.00 | 5.00 | 1.00 |
| 1 | 5.00 | 1.00 | 3.88 | 0.75 | 2.75 | 0.62 | 4.00 | 0.88 |
| 2 | 5.00 | 1.00 | 2.38 | 0.50 | 2.62 | 0.19 | 2.88 | 0.50 |
| 5 | 5.00 | 1.00 | 1.12 | 0.44 | 1.38 | 0.06 | 1.75 | 0.50 |
| 6 | 5.00 | 1.00 | 0.62 | 0.38 | 0.62 | 0.01 | 1.38 | 0.44 |
| 7 | 5.00 | 1.00 | 0.38 | 0.13 | 0.25 | 0.01 | 0.62 | 0.19 |
| 8 | 5.00 | 1.00 | 0.01 | 0.00 | 0.00 | 0.00 | 0.12 | 0.01 |

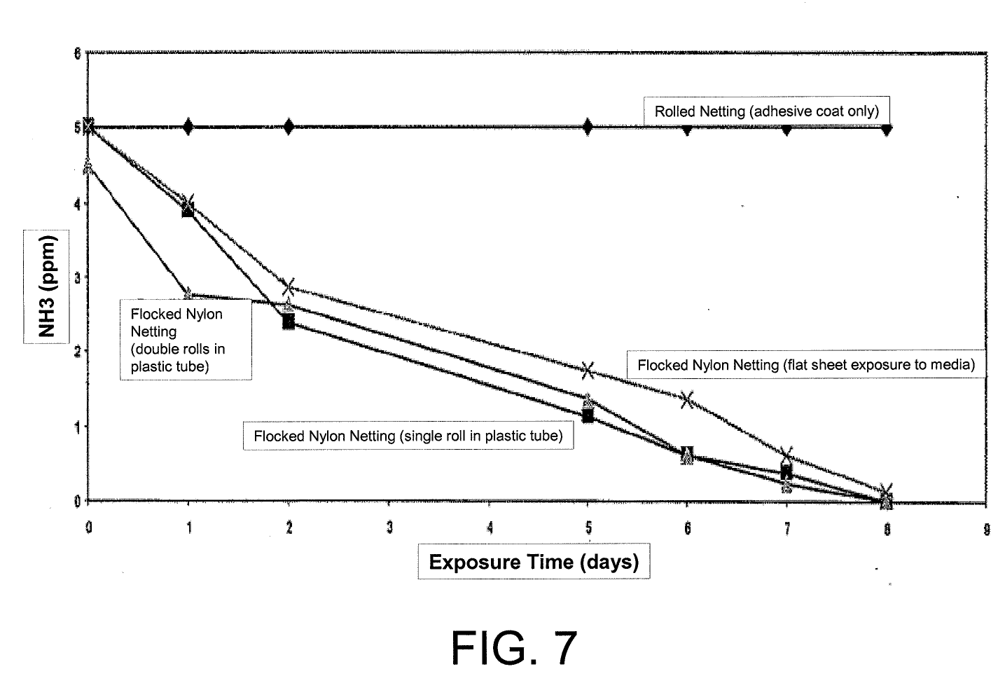

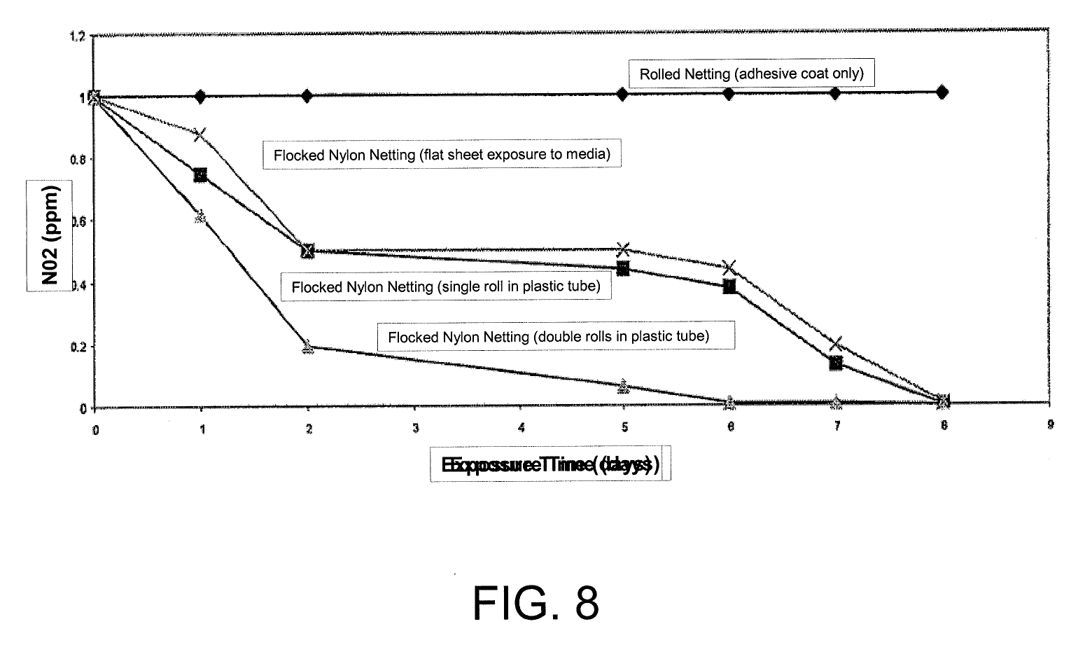

For additional comparison purposes, the data in Tables 6 and 7 were plotted in FIGS. 5, 6, 7 and 8. The bioconversion ability of flocked versus un-flocked surfaces is clearly shown. In these comparisons, both the ammonia and the nitrite bioconversion abilities must be considered. In FIGS. 5 and 6 the ⅜″ PET (adhesive coated) netting was the overall best base material. Note that the PET is the base fiber making up the netting material and is not expected to influence the bioconversion activity of the adhesive coated or the nylon flocked (using the same adhesive) substrates. FIGS. 7 and 8 also show the bioconversion effectiveness of flocked netting surfaces. With the exception of the ability of the “double roll” flocked netting to very effectively bioconvert nitrite ions (FIG. 8), the bioconversion effectiveness of the “rolled” and un-rolled (planar) flocked netting are similar. This is observed feature would help in the design of any future biofilter devices.

Recent biocompatibility test results indicate that polyvinyl chloride (PVC) surfaces enhance the growth of the ammonia-reducing bacteria. Bacterial growth on the bare PVC was much better than on the bare polycarbonate (PC) or glass surfaces. A most important observation was that the nylon flocked PVC plates and especially the (nylon flocked) corrugated PVC sheet material that is used in the Aquatic Eco-Systems RBC, exhibited superior visual growth of the bacterial cultures. Also, the rate of ammonia conversion on these flocked RBC and PVC panels was the highest among all the surfaces in the test. It appears that the choice of flocking nylon fibers onto PVC surfaces using the LUBRIZOL® FL 1059B water based acrylic adhesive is an excellent system for biofilter/bioconversion applications.

Other bioconversion test data are available showing that polyester (PET) fiber flock can also function to produce bioconversion flock surfaces. However, PET flock surfaces were not quite as effective as the nylon flock fiber material as described herein. Data are also available showing that ¾ inch nylon netting (very open mesh) netting exhibited very little bioconversion capability. It was poor. This suggests that there is an optimal range to the netting mesh opening size that is effective in the inducement of flocked netting bioconversion action. This “net opening size” range appears to be from below ¾ inch to a virtual zero open size which would be that for a flocked flat panel of fabric substrate. Flocked netting materials are the preferred embodiment of the invention.

### Example 5

### Bioconversion Efficiency of Flock Fiber Coated Surfaces

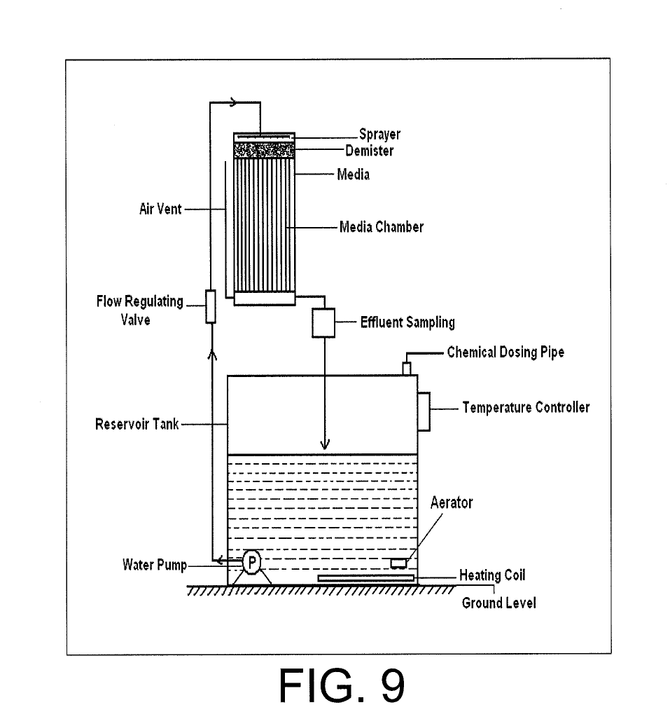

To determine the effect of flock fiber material type (nylon, polyester, cellulose acetate), flock density, fiber length on the bioconversion efficiency of flocked surfaces, an instrument controlled, laboratory scale bioconversion/biofilter tank system was constructed to carry out these experiments. Using the bioconversion of ammonia to nitrite and to nitrate using nitrobacter and nitrosomonas bacteria as the “model” biochemical conversion reaction was continued. While past RBC experiments demonstrated the enhanced bioconversion effects of flocked surfaces, work was now turned to using a Recirculating Trickling Biofilter (RTB) as the experimental bioconversion media materials testing methodology. A schematic of the trickling biofilter structure, referred to as a Biofilter Media Testing Module {BMTM} that was constructed is presented in FIG. 9. Two, identical BMTMs were constructed for this study. Here the biofilter media under test is placed in a chamber where water “contaminated” with ammonia is “trickled” through ammonia converting bacteria (nitrosomonas and nitrobacter) inoculated media.

The operating conditions for these two BMTM's are presented in Table 8. These conditions were kept constant during each ammonia bioconversion experiment described herein. In this study, two commercially available bio-media materials were evaluated for trickling biofilter effectiveness. These were chosen to be the “standard biofilter media” against which the experimental flocked fabric media will be compared. One of these media is a high surface area convoluted (open structure) “spiked” plastic balls known as Bio-Balls® [Aquatic Eco-Systems, Apopka, Fla.]. A picture of this media is presented in FIG. 10. Bio-Balls® have a surface area of 525 square meters per cubic meter of volume (160 ft2/ft3). Its packing density is 14.1 lbs/sq. foot. Of importance is that in practice, these Bio Balls® are virtually non-compressible. This medium fills the media holding chamber of the BMTM as 1″ diameter solid spheres. Bio-Ball® media is commonly used in the closed-system aquaculture industry. A second commercially available bio-media material, called Bio Fill® [Aquatic Eco-Systems, Apopka, Fla.] was selected as a comparative baseline media in this study. Bio-Fill® media (see FIG. 10) is a high surface area PVC straw-like mesh in the form of an approximately 2 mm wide ribbon mesh. It has a surface area of approximately 551 square meters per cubic meter (165 ft2/ft3) with a packing density of approximately 2.7 lbs per cubic foot.

Bio-Ball® and Bio-Fill® media were both evaluated in terms of the rate and overall ability of each media material to lower the ammonia concentration in the water reservoir under identical processing conditions. The side-by-side (identical) BMTM systems were employed to assure uniformity of the test conditions. Baseline experiments were started using nitrosomas and nitrobacter microorganisms as the bio-species in the ammonia-in-water biochemical remediation process. A typical “run” consists of starting the concentration of ammonia in both the biofilter tanks at approximately 9 to 10 ppm by the addition of ammonium hydroxide to a fixed volume of de-ionized water (300 liters) in the recirculating tank. The systems are then allowed to stabilize for two days by circulating the ammonia containing water through the biofilter media without inoculating the media. Then the biomedia is inoculated with nitrosomonas and nitrobacter bacteria once the pH and ammonia concentration in the tank have stabilized. The inoculation cycle is carried out over an eight-day period. The flow rate of water in both systems is kept constant; typically chosen to be from 0.5 to 2.5 gallons per minute. During this time, the ammonia concentration, pH, temperature are routinely measured and recorded. The drop in ammonia concentration from its original 9 to 10 ppm value signals the successful inoculation of the media.

The ammonia concentration is then continually followed until it reaches a low value of 1 to 3 ppm. Very low ammonia concentrations were avoided so the micro-bacteria would not be likely to “starve to death” thus destroying the bio-culture on the media. The attainment of this lower 1 to 3 ppm of ammonia concentration signifies the end of a “first” cycle. For a “second” cycle, another portion of ammonia (as NH₄OH) is added so that the reservoir tank ammonia concentration is again at the 9 to 10 ppm level. This starts the second cycle. This experiment is then continued for several ammonia cycles until several ammonia depletion rate “cycles” are obtained. Note that after the first “run”, a second and beyond “cycle” experiments can be carried out at different water flow rates without performing the inoculation step. This general procedure is used to evaluate the standard as well as experimental media.

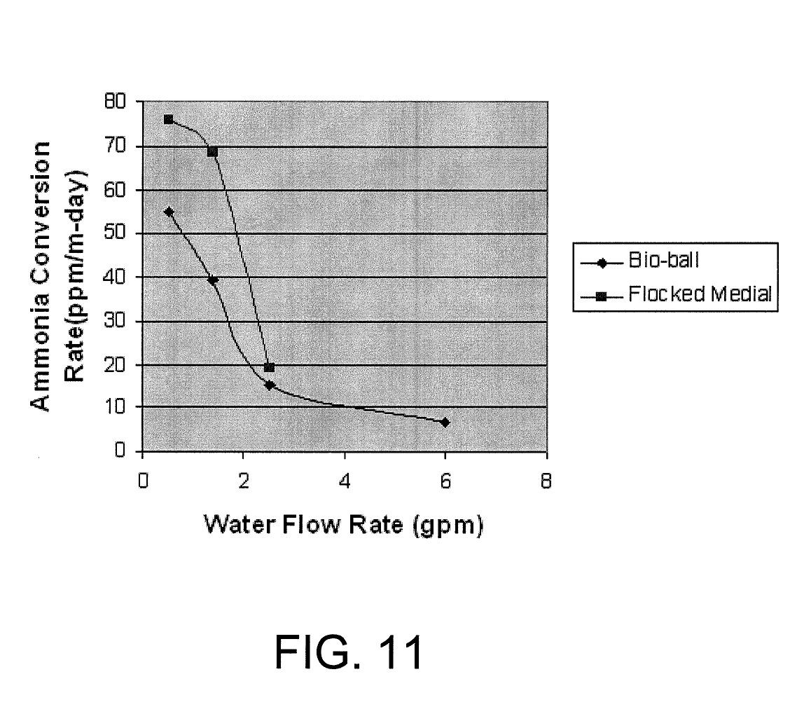

A summary of results on the standard “commercial” media is presented in Table 9. These data show that overall, the Bio-Ball® media is a slightly better biofilter media than the Bio-Fill®. Therefore, the Bio-Ball® media was chosen as the “standard” media material for use in continued studies. In view of this decision, a plot of ammonia depletion versus the flow rate in presented in FIG. 11. This represents the “standard” bio-conversion effectiveness plot against which experimental media data will be compared. In follow up to this, the ammonia bioconversion behavior of a flocked fabric experimental media material is also plotted in FIG. 11. These comparative data clearly show the superior bio-reactive effect of the flocked surfaced fabric media.

TABLE 8
List of Trickling Biofilter (BMTM) Operating Conditions.

| | |
|---|---|
| Volume of Water in Reservoir | 300 +/− 5 liters |
| Tank | |
| Volume of Media Test Chamber | 0.0297 cubic meters |
| Temperature of water | 25 +/− 1° C. |
| pH of water | 7 to 8 |
| Dissolved oxygen in water | 9 to 11 mg/liter |
| Approximate (induced) starting | 9 to 12 ppm (mg/liter) |
| ammonia nitrogen concentration | |
| for each ammonia depletion | |
| rate experiment. | |
| Water flow rates through Media | Must be set for each individual test. |
| test chamber | Generally 0.5 to 2.6 gallons per |
| (adjusted for each experimental | minute (GPM) is the range that has |
| run). | been used in this study. These flow |
| | rates apply to the flow of water |
| | through the 0.0297 m3 media test |
| | chamber of the BMTM |

TABLE 9
Comparison of Ammonia Depletion (bioconversion) Rates Between
Flocked Fabric Experimental Media Material and Commercial
“Standard” Media (Bio Ball ® and BioFill ®)(a)

| | | | ^{(d)}Flocked | ^{(d)}Flocked | ^{(d)}Flocked |
|---|---|---|---|---|---|
| | ⁽b⁾Bio- | | Fabric | Fabric | Fabric (e) |
| Flow | Balls ® | | (36.2 m² per | (50.1 m² per | (84.2 m² per |
| Rate | (15.4 m² | ⁽b⁾Bio-Fill ® | 0.0297 m³)(c) | 0.0297 m³)(c) | 0.0297 m³)(c) |
| (gallons/ | per | (24.4 m² per | 63-layers | 85-layers | 63-layers |
| minute) | 0.0297 m³)(c) | 0.0297 m³)(c) | fabric | fabric | fabric |
| 2.5 | 0.12 [4.04] | NA | 0.45 [15.2] | NA | NA |
| 1.5 | 1.14 [38.4] | 0.98 [33.0] | 1.92 [64.6] | 2.00 [67.3] | 3.1 [104.5] |
| 0.55 | 1.59 [53.5] | 1.24 [41.8] | 2.15 [72.4] | 2.25 [75.8] | 3.7 [124.6] |

(a)All the data represent depletion of ammonia in ppm (part per million)/day or [mg/liter-day] and are based on the actual 0.0297 m³ volume of media in the BMTM test chamber. To convert data to 1 cubic meter volume, divide these numbers by 0.0297. Data in brackets [ ] are surface areas normalized to a one cubic meter volume.
⁽b⁾Bio-Balls ® are “shaped” PE (1″ diameter) “spiked” open spheres; Bio-Fill ® is an assembly of (4.8 mm wide) PVC ribbon (straw-like) members (see FIG. 10). These are commercially available from Aquatic Eco-Systems, Apopka, FL
(c)Total overall surface area of media material in biofilter test chamber of 0.0297 m3 volume.
^{(d)}Flocked fabric prepared by flocking 15 to 18 denier, 3.8 mm long, nylon fibers onto a 20 holes per sq. inch PET netting fabric substrate using a water based acrylic flocking adhesive (LUBRIZOL ® FL1059B adhesive).
(e) This is an 8 hole per sq. inch PET netting fabric flocked with 18 D, 3.8 mm long nylon fiber configuration. Each of the 63 panels has a higher flock density than the 20 hole per sq. inch netting panel shown above.

### Example 6

### Flocked Biofiltration Media Surfaces

Studies of various experimental flocked fabric biofilter media configurations were carried out showing the superior bioconversion effectiveness of flocked fabric media. For example, in one particular test, at a 1.5 gallon per minute ammonia-water flow rate, a special flocked fabric configuration had a bioconversion rate of 3.1 ppm (ammonia)/day compared to a rate of 1.1 ppm (ammonia)/day for the Bio-Balls®. This special configuration was made by flocking the nylon flock fibers onto an 8 hole per sq. inch netting fabric at a high flock density. This configuration had the highest surface area of media packed into the bio-reaction chamber of the BMTM. This suggests the importance of the surface area (volume) packing of media in the bio-reaction chamber as a good criterion for high bioconversion rates. Overall, the data in Table 9 clearly show the superiority of flocked surfaces as biomedia compared to the Bio-Ball® and Bio-Fill® commercial media.

Performance data on some additional representative biofiltration media materials are presented in Table 9. Data on the commercial media and three configurations of flocked fabric media material are shown. The three experimental flocked media samples are the same except in the degree of packing in the media material in the BMTM test chamber. For all media tested, an increase in bio-conversion reaction rate occurs as the water flow rate decreases. Also, compared to the “standard” media, the higher bio-conversion rates for the flocked fabric surfaces are well demonstrated.

The data in Table 9 represent the bio-reaction rate based on the total volume of media that is enclosed in the BMTM's test chamber. For the commercial media and the 63 layer flocked fabric samples, the media is packed in a way to “comfortably” fill the test chamber. No extra force or packing pressure is used. For the 85 layered flocked fabric sample, the sample an additional 22 fabric layers were “squeezed” into the BMTM test chamber (in addition to the original, already present 63 layers). In another “run”, 63 layers of a “special configuration” flocked fabric were placed into the test chamber. Overall, this study was done in order to determine what affect a higher flocked fabric packing density and surface area effects would have on the bio-reaction rate.

As shown, the media volume based bio-reaction rate increases as the packing density and the surface area of the flocked fabric increases. As indicated based on a “normalized” 1 cubic meter volume, the surface area of the 63 layer flocked media increases from 1220 m²/m³ to 1687 m²/m³ for the 85 layered flocked, higher packing density media sample. Note that the specially flocked fabric sample had a surface area of 2835 m²/m³.

### Example 7

### Compact Trickling Biofilter Media Chamber—Design Calculation

Some model design calculations are presented showing that by using this specialty flock fabric media material in the bio-reactor media chamber, a Re-circulating Trickling Biofilter (RTB) device can be constructed having about ⅓ the (volume) media chamber size compared to the chamber size that would be needed if Bio-Balls® media were used in the same RTB bioconversion device. The media volume bio-conversion rate data of Table 9 enable one to design more compact (smaller volume) trickling biofilter installations. Here, the Bio-Ball's® bio-reaction rate performance can be taken as the “standard” reaction rate to be attained in a desired re-circulating trickling bio-reactor system. The “Volume Performance” of the flocked fabric media can now be compared on this basis.

For example: Choosing a flow rate of 1.5 GPM, it can be established from Table 9 that Bio-Balls® media has a bio-reaction performance rate of 38.4 ppm/m³-day. This can be set as the performance condition for a smaller, more compact RTB system. If flocked fabric media materials have a better bio-reaction performance at this same flow rate, it can be assumed that one would need a geometrically smaller (volume) bio-reactor to accomplish the same bio-reaction rate as the Bio-Balls®. Following this approach, the best bio-conversion rate results for a flocked fabric at 1.5 GPM flow rate (Table 9) is the special flocked fabric configuration which has a bio-conversion rate of 104.5 ppm/m³-day. To achieve or match the same bio-reaction rate as the Bio-Ball® containing media chamber, the volume of the flocked fabric media tank must be 38.4 divided by 104.5 or 37% fractionally smaller in volume than a comparably performing Bio-Ball® media containing tank. This means that if the original Bio-Ball® media containing tank was 1 cubic meter in volume, a comparably performing special flocked fabric material containing tank would have to be only 0.37 cubic meters in volume. A volume-of-tank reduction of 63% is achieved.

The final calculation in this exercise is to determine the “residence time” the ammonia-water must have in this smaller, flocked fabric media containing trickling biofilter tank. Therefore the ammonia-water flow rate through the media chamber must be adjusted in this smaller tank volume to give a residence time of 5.2 minutes. This is the residence time of the ammonia-water has in the experimental 0.0297 m³ BMTM tank at a 1.5 gallons per minute flow rate. This is the time it takes a 0.0297 m³ volume of the reservoir water to empty the media containing tank; this value can be taken as the time the ammonia water has in contact with the media. Since there are 12.46 increments of this 0.0297 m³ volume in this newly “sized” 0.37 m³ volume tank, this means that a flow rate of 18.7 GPM will be needed to pass through this smaller tank. This is an achievable flow rate level. Based on these calculations a suitable, much smaller, RTB device can be constructed. This example illustrates how data such as is given in Table 9 can be used to design and construct smaller, more compact re-circulating trickling biofilter devices for ammonia-water bio-remediation. Flocked fabric media materials having much higher bioconversion effectiveness than the example cited above can be developed.

Based on experiments using three different biofiltration techniques: (1) Laboratory Screening Tests, (2) Rotational Biological Compactor (RBC) a commonly used commercial biofiltration process and (3) Re-circulating Trickling Biofilter (RTB) technique, flocked fabric surfaces are more effective than “control” and commercially available media materials in the bio-remediation of ammonia-in-water applications. From trickling biofilter experiments, it is demonstrated that on a volume of media basis, flocked fabric experimental media are superior to Bio-Ball® and Bio-Fill® commercially available biofilter media for the bio-conversion of ammonia in water. An example calculation, using data existing to date, show that a volume reduction of a trickling biofilter media/chamber apparatus of almost two thirds (⅔) compared to the standard Bio-Balls®, is possible using flocked fabric as the biofilter media. It appears that the overall influencing parameters that control the volume based bio-conversion of media materials are (a) the available-to-the-bacteria surface area of the particular media and (b) the flow rate of ammonia-water that is trickled through the media material. The ammonia bio-remediation effectiveness of flocked fabric surfaces increases as the surface area (per volume) of the flocked fabric surfaces increases. However, this effect is not exactly proportional. The bioconversion rate value falls to less than 90% of the expected doubling value of bio-reaction rate.

In additional experiments, the ammonia bioconversion rate of all tested media increases as the flow rate of ammonia containing water through the media decreases. This effect is independent of the surface area of the media being tested. A trend was observed in that the higher the surface area of the media enclosed in the 0.0297 m³ media chamber, the less is the effect of flow rate on bioconversion effectiveness. For example, for Bio-Ball media (surface area 17.8 m² in 0.0297 m³ of chamber volume), the bioconversion effectiveness increase by changing from a 1.5 gpm to 0.5 gpm flow rate is 0.0253 ppm ammonia/day. The same change in flow rate for higher surface area media such as flocked media (surface area from 185.3 to 47.6 m²/0.0297 m³ chamber volume) ranges from 0.0006 to 0.0031 ppm ammonia/day increase in bioconversion rate.

### Example 8

### Effect of Nutrients on Ammonia Removal Effectiveness of Flocked Media

It was found that the presence of nutrients in the tank water increases the growth rate of nitrosomonas and nitrobacter bacteria. During the inoculation period glucose (1 gram per liter) and disodium phosphate (0.1 gram per liter) were introduced as nutrients in the bio-filter re-circulation tank along with the ammonium hydroxide. In the no-nutrient studies, only ammonium hydroxide is injected into the bio-reactor (reservoir) tank. The concentration of ammonium hydroxide in the tank was initially set at 10-11 mg/liter.

The composition of the bioreactor tank solution during the inoculation period in the presence and absence of nutrients is presented in Table 10.

TABLE 10
Composition of Bioreactor Tank Solution (per 300 L total volume).

| Chemical Ingredient | Without Nutrient | With Nutrient |
|---|---|---|
| Ammonium Hydroxide | 85 ml | 85 ml |
| Glucose (Carbon Source) | None added | 1 gram/liter |
| Disodium Phosphate | None added | 0.1 gram/liter |
| (Phosphate Source) | | |

After the inoculation period, 0.1 gm glucose and 0.01 gm of di-sodium phosphate was added daily until the experiment is over. It has been found that during the actual bio-reaction tests around 60-70% of the above nutrients were consumed.

### Effect of Nutrients on the Ammonia Depletion Rates

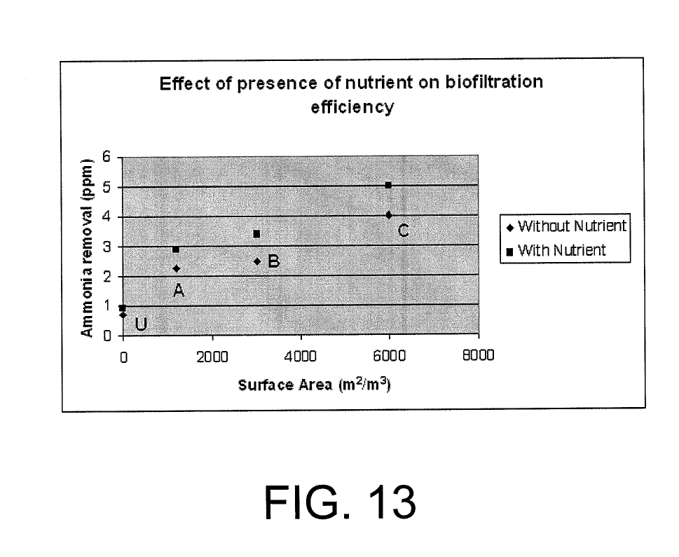

The effects of nutrients on ammonia removal rates obtained by flocked media are shown in FIG. 13. The configurations of flocked media studied are presented in Table 11. All the readings are noted at the flow rate of 0.5 gpm. It has been found that nutrients have a positive effect on ammonia removal rates.

TABLE 11
Flocked Fiber Media Configurations Used in FIG. 11.

| Point on Graph | Type of Netting | Flock Fiber |
|---|---|---|
| A | 20 Holes/in² | 18D Nylon |
| B | 8 Holes/in² | 18D Nylon |
| C | 8 Holes/in² | 18D Nylon |
| U | 8 Holes/in² | Not Flocked |

It is found that the presence of nutrient improves the rate of ammonia removal of flocked media by 27-35%. Nutrients in the bath tend to maximize the growth rate of bacteria on the media surfaces; the biomass layer build-up was found to be much thicker when the bio-reaction was made to occur in the presence of nutrients. These results show that the flocked media's effectiveness is not hindered by nutrients in the tank water. Nutrients in the tank water are common in actual aquaculture and other waste-water treatment operations. From these results, the successful use of flocked media systems in aquaculture and other waste-water treatment applications is anticipated.

### Example 9

### Dynamic Response of Flocked Media

Dynamic concentration flux in a bio-reactor tank system is a response of the bioreactor to fluctuations in pollutant concentrations in the system. It is important to check the flocked media's response to these fluctuating ammonia concentrations before using it for aquaculture bio-filtration system. In aquaculture systems, fish food is added to the tank 3-4 times a week. This food injection causes an almost immediate increase in the ammonium ion concentration in the tank. The bioreactor media should respond to these concentration changes quickly and should keep the concentration of ammonium ion under control. If media doesn't respond quickly enough to these changes the fish product in the tank may become ill or be killed.

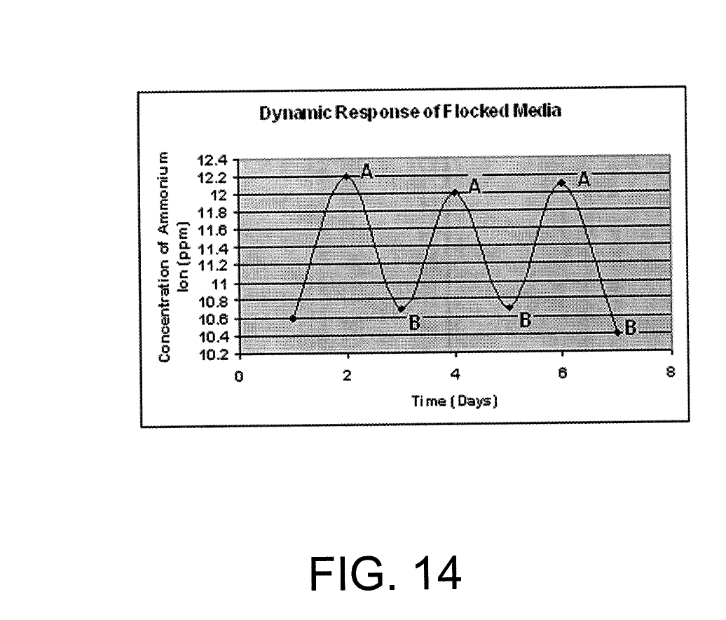

To test dynamic response of flock media, 18D nylon fiber flocked, 20 holes polyester netting (1200 m²) was selected. Set volumes of ammonium hydroxide were injected after each 24 hours; the ammonium ion drop rate was subsequently noted. These experiments were carried out at a flow rate of 0.5 gpm. The dynamic response of flocked media is shown in FIG. 14.

Point A indicates the injection of ammonium hydroxide into the tank whereas point B indicates the drop in concentration of ammonium ion in 24 hours. It is clear from the graph that to every injection of ammonium hydroxide into the tank, flocked media behaves in similar manner and reduces ammonium ion concentration at a similar depletion rate range i.e. between 1.6-1.7 ppm/day. This study shows that flocked media can handle any rapid concentration changes that may occur in the aquaculture tank and hence maintain the concentration limits of ammonium ion within safe limits.

### Example 10

### Ammonia Bioconversion Effectiveness of Adhesive Coated (only) Netting Media Layers in the Test Module's Media Chamber

To provide a “control and baseline” for the bioconversion effectiveness behavior of flocked netting media materials, experiments were carried out on adhesive coated (not flocked) netting and fabric material as media. In these experiments, the BMTM chamber of the biofilter test module was completely packed with adhesive coated (only) netting media panels (not flocked). In one experiment, 67 layers of adhesive coated netting were placed in the BMTM media test chamber. Here, the media test chamber was only partially filled. 63 panel layers was the same number of media layers used in the test chamber when flocked netting was tested. In another experiment, 151 panels of adhesive coated only polyester netting (8 holes/square inch) were fitted into the biofilter media test module. This test chamber was fully packed. Following the developed experimental procedure, the ammonia depletion rate of these two media configurations (partial and fully packed media chamber) was determined. These data are summarized in Table 12.

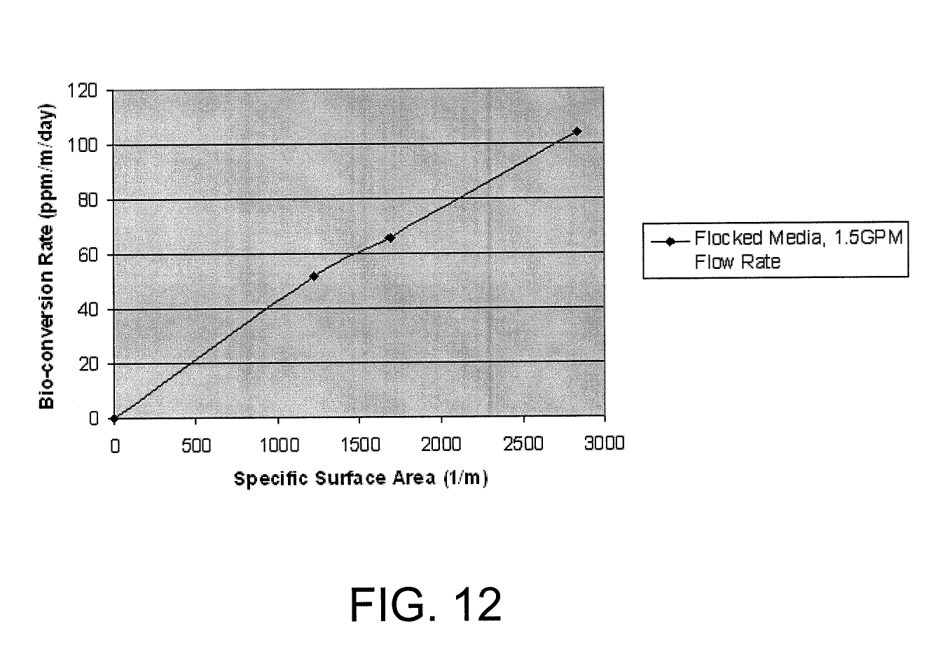

It was observed that only 0.7 ppm ammonia per day was bioconverted in the partially filled media chamber while 1.1 ppm of ammonium ion concentration was depleted per day by fully packed media chamber. All data were for a flow rate of 0.5 gpm. This increased bioconversion effectiveness is most likely due to the increase in surface area in the fully packed (151 layers) media chamber. On another point, however, while both the same number of media panels were placed in each of the testing chambers, (comparing the flocked netting and adhesive coated netting configurations) the 67 non-flocked adhesive coated panels did not completely fill the media chamber. These panels were not uniformly positioned in the chamber. They were folded and bent leaving much open volume/space compared to the 151 layer adhesive coated netting (fully packed) chamber experiment. The flow of water through this 67 media panel containing chamber was not uniform. In comparison, when the 67 layers of flocked 8 holes/sq. inch netting was tested, it completely filled the media chamber; water flow here was more uniform throughout the media holding chamber. Finally, Table 12 includes data showing the positive effect of that flocked netting has on greatly increasing the surface area and bioconversion effectiveness of this netting based media. FIG. 12 was prepared to more clearly show the effect of surface area of flocked fabric surfaces on the bioconversion reaction rate.

TABLE 12
Bioconversion Effectiveness of Adhesive Coated Netting (a).

| | Panels in Media | Bulk Surface | Bioconversion |
|---|---|---|---|
| Media material | Chamber | Area | Rate (ppm |
| (netting base) | (number) | (m²/m³) | ammonia/day) |
| Adhesive Coated | 67 | 325 | 0.7 |
| (part) (b) | | | |
| Adhesive Coated | 151 | 732 | 1.1 |
| (full) (b) | | | |
| Flocked netting (b)(c) | 67 | 2800 | 2.5 |
| Flocked netting (c)(d) | 63 | 1200 | 2.2 |
| Flocked netting (c)(d) | 87 | 1687 | 2.4 |

(a) All data at 0.5 gpm water flow rate.
(b) 8 holes/sq, inch netting.
(c) Flocked with 18 D, 0.180″ long flock fibers.
(d) 20 holes/sq. inch netting.

It is observed that 0.7 ppm of ammonia per day was depleted for polyester (adhesive coated only) netting compared to a drop of 2.5 ppm per day for the flocked fabric with the same netting as its base.

### Example 11

### Ammonia Bioconversion Capability of Fully Flocked (not netting) Textile Fabric

An experiment was carried out to determine the ammonia depletion rate of planar, nylon fiber flocked panels of textile fabric. The effect of a fully flocked, not a netting material, fabric panel was determined. Here 100% scoured cotton was used as the base fabric. Note here that the base fabric material is not biochemically or chemically important since the fabric is coated with the flock adhesive that encapsulates the fabric. This woven cotton fabric was coated (primed) with acrylic adhesive using a paint roller. It was then dried for 12 hours. The dried fabric was then given a second coat of adhesive (second priming) and later dried again in air for 12 hours. These two coatings of adhesive layer made cotton fabric quite stiff. Nevertheless, the adhesive coated fabric was again coated (wet adhesive) and then flocked using 18D nylon 0.180″ long fibers on both sides. The flocked fabric was dried at room temperature for 12 hours. Finally, these air-dried flocked fabric panels then were heated in a curing oven at 80° C. for 2 hours. The cured flocked panels were vacuumed and then washed for two days in running tap water to remove surfactants and other impurities induced into the system by the (water based) acrylic flocking adhesive.

Washed panels were then dried and placed in the media test chamber for bacteria inoculation and bioconversion testing in the Biofilter Media Test Module (BMTM). A total of 59 panels, both sided flocked, were placed in the bioreactor chamber. The bulk surface area of this flocked fabric media was 6240 m²/m³. As typically carried out, the media was then inoculated for 8 days followed by measuring the ammonium ion depletion rate. The flow rate for this test was 0.5 gpm. Here, it was observed that ammonium ion was depleted at the rate of 3.9 ppm per day. This configuration yielded a high ammonia depletion rate. The only problem encountered was that of fabric panel stiffness. Fabric panels that were prepared were quite stiff in the dry state but became a softer when immersed in water. The flocked polyester netting materials (8 holes/square inch) were also stiff during their biofiltration operation. A summary of the bioconversion rate data for these “Control” media materials is presented in Table 13.

TABLE 13
Summary of Ammonium Depletion Bio-reactivity of Base and
“Sample Control” Materials Used in this Study (a).

| | | | Ammonium Ion |
|---|---|---|---|
| | # of Ply | Bulk Surface | Depletion Rate |
| Base Media Material | Layers | Area (m²/m³) | (ppm/day) |
| Adhesive Coated Netting | 67 | 325 | 0.7 |
| (Loose Packed) | | | |
| Adhesive Coated Netting | 151 | 732 | 1.1 |
| (Full Packed) | | | |
| Flocked Netting (b)(c) | 67 | 2800 | 2.5 |
| Both Side Planar Flocked | 59 | 6240 | 3.9 |
| Fabric Panels | | | |
| (not netting) (b) | | | |
| Adhesive Coated Fabric | 210 | 1453 | 1.2 |
| (not netting) (not flocked) | | | |

(a) all tests at 0.5 gpm flow rates
(b) 18D nylon flock, 0.180″ long
(c) 8 hole/sq. in. netting.
(d) Some of these data are also presented in Table 12.

From Table 13 it is obvious that the adhesive coated (not flocked) netting, no matter how many layers are packed into the media chamber, cannot match the bioconversion effectiveness of the flocked (planar) fabric or the flocked netting. This is because much more “surface area” can be packed into the media test chamber volume when the media is made using flocked fiber surfaces. However, a comparison of the two-sided flocked (planar) fabric media and the flocked netting media presents some useful considerations. First as mentioned previously, the fully flocked media panel (not netting) was found to be much better in its bioconversion properties compared to the similarly flocked netting. This flocked planar fabric is superior bioconversion-wise to the adhesive coated “control” media panel even though 210 panels per packed into the media chamber. Again, flocked surfaces/media have always been found to have enhanced bioconversion effectiveness.

Regarding the flat panel, (not netting media configuration), another factor is worthy of note. Because of water flow requirements, this planar fabric media configuration can only be arranged in the media chamber as parallel plates or a rolled up cylinder. It must be positioned in the test module's media chamber as an open-ended, slotted, assembly that is oriented parallel to the flow of water. This is the only orientation that will still allow water to smoothly flow through it. This feature may not cause any problems for some biofilter designs. On the other hand, the flocked netting fabric media configuration can be arranged in many ways. Flocked netting fabric can be stacked in the media (flow through) chamber as, (1) parallel plates, (2) perpendicular layers, (3) folded layers or as rolled up cylinders. The inherent nature of the netting (open holes) allows for this versatile media orientation. This orientation versatility is not readily available with the “solid flocked fabric” configuration. A folded or stacked layer of this flat (planar) flocked fabric will greatly restrict the flow of water through the plane of the fabric. Regardless, these results clearly demonstrate the overall versatility of flocked media in designing ammonia-in-water bioreactors.

It might be desirable in the actual design of operating biofiltration systems to have the media in one single piece as a roll or continuous sheet. If re-cycling or rejuvenation of the media is required, the flocked netting media material will be much more adaptable to a refurbishing or cleaning process involving its being flushed out with a spray of water.

### Possibilities for Other Textile Fabric Media Configurations

Another important result from this experiment on testing flat fabric flocked media panels is the possibility that other forms of textile fabric materials, such as velvet, velour, napped, terry-cloth, raised fiber fabric, etc. can be used as effective biofilter media materials. These may prove useful in developing compact, space saving media materials for biofilter applications.

### Example 12

### PC Plates Flocked with Nylon Fibers

In one study, it was found that 3/16 inch thick polycarbonate (PC) plates flocked with nylon fibers are an excellent substrate for ammonia converting nitrosomonas and nitrobacter bacteria. During ammonia contaminated water immersion testing, all the flocked samples showed a rapid decrease in ammonia concentration accompanied by an increase in nitrate concentration. All the flocked panels showed a visibly heavy growth of bacteria on their surfaces compared to the controls. Similar studies on textile fabric surfaces, flocked with nylon fibers also showed remarkable bioconversion activity. It appears that flock fiber material with a large surface is an important factor in this observed enhanced bioconversion effect.

Other embodiments of the bioconversion surface materials disclosed herein, and methods for their application and use, are envisioned beyond those exemplarily described herein.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize, or be able to ascertain, using no more than routine experimentation, equivalents to the specific embodiments of the invention. It is therefore to be understood that the embodiments described herein are presented by way of example only and that, within the scope of the appended claims and equivalents thereto, the invention may be practiced otherwise than as specifically described.

What is claimed is:

1. A biological growth support media, comprising:
a textile biofiltration media substrate; and
an array of fibers disposed on a surface of the textile biofiltration media substrate.

2. The media of claim 1, wherein the fibers are oriented substantially perpendicularly relative to the surface of the substrate.

3. The media of claim 1, wherein a density of the fiber array on the textile substrate is at least about 20 fibers per square millimeter.

4. The media of claim 1, wherein the array of fibers is secured to the textile substrate by an electrostatic coating method or a flocking method.

5. The media of claim 4, wherein the substrate is substantially planar woven, knitted, or non-woven fabric or panel.

6. The media of claim 4, wherein the substrate comprises a netting fabric, a perforated woven fabric, or a metal wire screen.

7. The media of claim 6, wherein the array of fibers comprise nylon, polyester, acrylic, stainless steel, polyolefin, cellulose acetate or a combination thereof.

8. The media of claim 1, wherein the substrate comprises nylon, polyester, acrylic, cotton, nitrile, stainless steel fibers or a combination thereof.

9. The media of claim 1, wherein the array of fibers comprise nylon, polyester, acrylic, or polyolefin filaments with a diameter of from about 2 micrometers to about 50 micrometers.

10. The media of claim 1, wherein the array of fibers are of from about 0.25 millimeters to about 10 millimeters in length.

11. The media of claim 6, wherein the surface of the substrate defines a plurality of apertures in the range of about 0.25 millimeter to about 12.7 millimeters in circular diameter, square or open rectangular shape.

12. The media of claim 8, wherein the substrate comprises a plurality of layers constructed and arranged to facilitate fluid bypass through a plane of the substrate.

13. The media of claim 8, wherein the substrate is a substantially flat surface or is rolled to define an open conduit constructed and arranged to channel fluid flow.

14. The media of claim 2, wherein the substrate is constructed and arranged such that a fluid stream flows substantially parallel to the surface of the substrate, across ends of the perpendicularly oriented fibers for treatment.

15. The media of claim 1, wherein the textile biofiltration media substrate comprises a woven, knitted or nonwoven fabric that has undergone a raising, napping and/or brushing process.

16. The media of claim 1, wherein the substrate comprises a planar plastic sheet, a planar fabric sheet, a netting, a woven screen, or a knitted screen.

17. The media of claim 16, wherein the substrate comprises a polyvinylchloride, polyacrylic or polycarbonate planar plastic sheet.
